(19) United States
(12) Patent Application Publication
(10) Pub. No.: US 2020/0236925 A1
(43) Pub. Date: Jul. 30, 2020

(54) METHODS AND FORMULATIONS FOR PREVENTING DOWNWARD MIGRATION OF AGRICULTURAL MATERIALS

(71) Applicant: BAYER CROPSCIENCE LP, Cary, NC (US)

(72) Inventors: Kenneth J. Essig, Wake Forest, NC (US); Bruce R. Spesard, Wake Forest, NC (US); Thomas James Queck, JR., Raleigh, NC (US); Sheryl Wells, High Springs, FL (US); Aileen Shieh, Raleigh, NC (US)

(21) Appl. No.: 16/749,664

(22) Filed: Jan. 22, 2020

Related U.S. Application Data
(60) Provisional application No. 62/796,213, filed on Jan. 24, 2019.

(51) Int. Cl. A01N 25/04; A01N 43/68

(52) U.S. Cl. CPC A01N 25/04; A01N 43/68

(57) ABSTRACT

A method of reducing downward migration of a pesticide (optionally in soil or turf), comprising applying a composition comprising a pesticide that is solubilized in a water-immiscible solvent to form an oil in water emulsion or an emulsifiable concentrate, wherein said pesticide exhibits superior performance against a targeted pest due to decreased downward migration in soil as compared with said pesticide which is not in an oil in water emulsion or emulsifiable concentrate form.

### CROSS-REFERENCE TO RELATED APPLICATIONS

This application claims priority to U.S. provisional Application No. 62/796,213, filed 24 Jan. 2019, which is incorporated by reference in its entirety.

### BACKGROUND OF INVENTION

### Field of the Invention

The invention relates generally to methods and formulations for preventing downward migration of agricultural materials.

### Background Art

The challenge in agrochemistry or other large-scale field applications of chemicals or active agents, such as pesticides, herbicides, bacteriocides, nematicide and fungicides, is to find ways of achieving control of the target organism while limiting the amount of the xenobiotic substance that is loaded into and is free-moving in the ecosystem by downward migration or by aerosol drift. The amount of such chemical that is required is a function of their potency, the ability to place the chemical selectively and their susceptibility to removal either via destruction in the environment (metabolism, photolysis, etc.) or loss (downward migration, drift). Unfortunately, environmentally desirable properties such as facile biodegradation or other loss may result in a need for frequent re-application and thus an increase in the load on the environment. Although there has been dramatic progress in identifying more potent active agents for use in pest control, there has been rather less success in controlling the application or placing of these chemicals in such a way as to limit losses and maximize efficacy.

When a chemical is applied to soil, it does not always stay put. Chemicals follow any number of pathways. They can enter plants, insects, and other living organisms. They can volatilize, which means they change into a gas. They can be broken down by sunlight, microorganisms, or chemical reactions with water, and they can chemically attach to soil and organic particles. They can also remain in a dissolved form, and then leach with water through the soil, sometimes winding up in groundwater. The fate of mobile chemicals, however, can be thought of as a race between the various degradation processes and downward migration to groundwater.

Downward migration is the movement of contaminants, such as water-soluble pesticides or fertilizers, carried by water downward through permeable soils. Most pesticides adsorb to soil particles (especially clay), become immobile, and do not leach. The fate of mobile pesticides, however, can be thought of as a race between the various degradation processes and downward migration to groundwater. In contrast to surface water, groundwater does not continually dilute the contaminants that reach it. Flushing a plume of contamination from groundwater may take many years. The cold temperatures, limited microbiological activity, lack of sunlight and low oxygen levels that are found deep beneath the soil surface, slow chemical breakdown. The result is that there is very little, if any, breakdown of chemicals once they reach an aquifer. Thus, chemicals often do not reach their intended target but are transported to groundwater and surface waters.

U.S. Pat. No. 7,874,101 discloses a method of applying a water-soluble soil stabilizer to soil including adding said water-soluble soil stabilizer to a solid carrier; releasing said water-soluble soil stabilizer out of said solid carrier into said soil; binding said water-soluble soil stabilizer to said soil; in which application rates of said solid carrier to said soil is based on a desired amount of said water-soluble soil stabilizer to be metered to said soil.

U.S. Pat. No. 8,925,244 discloses a method of controlling the movements of biosolids before, during, and after land application of said biosolids comprising; combining WSPAM (water soluble polyacrylamide) and said biosolids to form amended biosolids, in which said combination occurs prior to land application; combining said WSPAM and said biosolids in a desired ratio using industry standard feeding equipment; metering said amended biosolids to said soil; binding said amended biosolids to said soil; controlling amount of said WSPAM metered to said soil by rate of said biosolids metered to said soil; said amended biosolids comprising a mixture of about 0.01% to 85% weight percent solids.

U.S. Pat. No. 9,301,454 discloses a method of improving the water holding capacity, resistance to downward migration of nutrients and/or pesticides from, and/or improving the hydrophilicity of peat moss consisting of incorporating in the peat moss one or more polysaccharides selected from the group consisting of hydroxypropyl guar (HP guar), cationic hydrophobically modified hydroxypropyl guar (cationic HMHP guar), and hydrophobically modified cationic guar (HM cationic guar); spraying or mixing a powder, solution, suspension, and/or premix of a controlled concentration of the one or more polysaccharides on or in the peat moss substrate.

U.S. Pat. No. 9,873,639 discloses a method for minimizing downward migration of an active agent into water sources including applying to soil a composition containing biochar, at least one nitrogen source, at least one organic acid and at least one active agent wherein the biochar is impregnated with about 5% wt to about 45% wt of the active agent, and further wherein the biochar has a bulk density of less than about 40 pounds per cubic foot and has a size of about 90-100% passing through a ¼″ mesh screen and about 50% or more passing through a 4 mesh screen; or a size of about 90-100% passing through a No. 4 mesh screen and about 70% or more passing through a No. 10 mesh screen; or a size of about 90-100% passing through a No. 10 mesh screen and about 50% or more passing through a No. 45 mesh screen.

Indaziflam also known as BCS AA-10717 or AE 1170437, was first introduced into the marketplace in the year 2010 as Specticle®. Indaziflam is a selective pre-emergence (PRE) alkylazine herbicide that inhibits cellulose biosynthesis in susceptible species. It is currently registered for use in commercial nurseries, commercial/residential lawns, forestry sites, golf courses, highway rights-of-way, landscape plantings, ornamentals, sod farms, and sports fields. Indaziflam controls many monocotyledonous and dicotyledonous weeds including annual bluegrass (Poa annua L.), crabgrass (Digitaria spp.), goosegrass [Eleusine indica (L.) Gaertn.], lawn burweed (Soliva sessilis Ruiz & Pay.), and yellow woodsorrel (Oxalis stricta L.). Additionally, indaziflam provides an alternative mode of action for PRE control of dinitroaniline-resistant annual grassy weeds in the southern United States. Indaziflam is currently labeled for use on several warm season turfgrasses including bahiagrass (Paspalum notatum Fluegge), buffalograss [Bouteloua dactyloides (Nutt.) J. T. Columbus], centipedegrass [Eremochloa ophiuroides (Munro) Hack.], common bermudagrass [Cynodon dactylon (L.) Pers.], hybrid bermudagrass, St. Augustinegrass [Stenotaphrum secundatum (Walt.) Ktze.], and zoysiagrass (Zoysia spp.).

In 2011, reports surfaced alleging indaziflam adversely affected select warm season turfgrass species. Specifically, severe damage was reported on seashore paspalum (Paspalum vaginatum Sw.), which was removed from the label; while isolated injury was also reported on hybrid bermudagrass. Turfgrass injury from indaziflam has been described as canopy thinning, reduced lateral spread/recovery, and unacceptable turfgrass quality. Hybrid bermudagrass is a perennial turfgrass species widely used for commercial/residential lawns, golf courses, and sports fields. It is well adapted for these areas due to superior recuperative ability following heavy traffic, fine texture, and excellent drought tolerance. However, shade can reduce the performance of bermudagrass, making it more susceptible to other abiotic/biotic stresses. While speculation exists on factors that influence hybrid bermudagrass injury from indaziflam, much is based on anecdotal observations. Bermudagrass injury from indaziflam has been previously investigated although results varied among soils, environments, and locations. Greenhouse experiments have largely focused on subsurface conditions, while field experiments have focused on hybrid bermudagrass establishment and rooting following indaziflam application. Jones et al. (2013b) correlated foliar hybrid bermudagrass injury and root length reduction with indaziflam applications in areas with rooting depths ≤15 cm. Furthermore, indaziflam-hybrid-bermudagrass injury may increase in environments with minimal soil organic carbon (SOC) or clay content. Previous greenhouse research also suggests hybrid bermudagrass injury may be reduced by lowering application rates. Injury increased >10-fold as indaziflam application rate increased from 35 to 53 g ha-1 when SOC ≤0.3% w w-1. Field trials by Gomez de Barreda (2013) determined that centipedegrass, St. Augustinegrass, and zoysiagrass could be successfully established vegetatively on a Cecil sandy clay loam (fine, kaolinitic, thermic Typic Kanhapludult) in the spring following fall indaziflam application; however, hybrid bermudagrass could not be successfully established from seed. Webster (2011) reported no differences in hybrid bermudagrass root strength between nontreated and indaziflam (35 or 52 g ha-1) fall or spring treatments; however, the authors did not evaluate indaziflam applied in both seasons, which may be practiced by end-users. Previous research has shown hybrid bermudagrass herbicide tolerance may vary as it enters or comes out of dormancy in the fall and spring, respectively. Herbicide physicochemical properties including, but not limited to, aqueous solubility (Ks), soil sorption coefficient (Kd), organic carbon sorption coefficient (Koc), ionizability, and persistence may influence herbicide bioavailability and efficacy. Furthermore, soil physical and chemical properties including texture, organic C content, clay content/type, pH, and cation exchange capacity may also affect herbicide distribution in the soil profile as well as bioavailability. The dissociation constant of indaziflam is 3.5, while the field-T1/2 (>150 d), Ks (2.4 mg L-1; pH 7), Kd (4.9-27.4 mL g-1), and Koc (434-1544 mL g-1) suggest it may be moderately mobile in soil due to long persistence coupled with low to moderate sorption coefficients. Jhala et al. (2012) reported indaziflam leached 30 cm under 15 cm of simulated rainfall compared to 13 cm under 5 cm of simulated rainfall shortly after application, indicating downward distribution and activity in soil was affected by moisture inputs. Since indaziflam is root-absorbed, downward movement of this herbicide in soil may attribute to cases where hybrid bermudagrass injury has occurred. Similar effects may also occur with other actives due to the same conditions. See, Agron. J. 108:950-956 (2016)—published Apr. 22, 2016.

The above has provided some information for safe and effective indaziflam deployment in turf, especially at high risk sites (coarse textured soils having low SOM). Despite the tolerance limitations of indaziflam, it is a highly desired herbicide by end-users due to its spectrum and length of weed control, low use rates, and alternative mode of action.

As such, there remains a need for improved retention of active agents for agriculture in a manner that reduces loss of actives such as indaziflam to downward migration.

### SUMMARY OF INVENTION

A method of reducing downward migration of a pesticide optionally a herbicide, said method, comprising:

applying to the soil/growing media within which is grown a plant, a composition comprising a pesticide that solubilized in a water-immiscible solvent to form an oil in water emulsion or form an emulsifiable concentrate,

wherein the pesticide exhibits superior performance against a targeted pest due to decreased downward migration in soil as compared with said pesticide which is not in an oil in water emulsion form or an emulsifiable concentrate.

There is also provided a composition that is resistant to downward migration when applied to soil, said composition comprising a herbicide a solvent, a polymeric emulsifier, and optionally one or more additives, antifoam agents, antimicrobial agents and balance water, wherein at least said herbicide and said solvent are in an oil in water emulsion and said herbicide is optionally completely dissolved in said solvent.

Other aspects and advantages of the invention will be apparent from the following description and the appended claims.

### BRIEF DESCRIPTION OF THE DRAWINGS

FIGS. 1-9 depict embodiments as disclosed herein.

FIG. 1 shows a column containing high sand, low organic matter soil. The Formulation of interest is uniformly applied to the soil surface and allowed to dry. A significant irrigation event follows to effectively move the herbicide through the soil profile.

FIG. 2 shows after the irrigation event, a seeding window is cut into the side of the columns, the columns are capped and laid on their side. A defined quantity of perennial ryegrass seed is planted within the seeding windows. The seed germinates within days.

FIGS. 3-5 shows harvested perennial ryegrass. The left side of each picture corresponds with the top of the column. FIG. 3 (Left) corresponds to Untreated Control. Note roots growing throughout. FIG. 4 (Center) corresponds to Reference/Standard Formulation (Specticle FLO). Note the depth to which the herbicide moved down through the column, as evidenced by lack of roots/root inhibition. FIG. 5 (Right) corresponds to Experimental formulation. Note the resumption of root growth higher in the soil profile vs. the Reference Formulation.

FIG. 6 shows CYNDA (‘Celebration’ bermudagrass) injury over time after application of Experimental Formulations compared to that of the Standard, Specticle FLO.

FIG. 7 shows CYNDA (‘Celebration’ bermudagrass) turf quality over time after application of Experimental Formulations compared to that of the Standard, Specticle FLO.

FIG. 8 shows STPSE (‘Floratam’ St. Augustinegrass) injury over time after application of Experimental Formulations compared to that of the Standard, Specticle FLO.

FIG. 9 shows STPSE (‘Floratam’ St. Augustinegrass) turf quality over time after application of Experimental Formulations compared to that of the Standard, Specticle FLO.

### DETAILED DESCRIPTION

The main problem with the use of less persistent conventional herbicides that have greater specificity is the use of excess amounts than that actually required to control the herb because they are unstable in an aquatic environment and of the need to compensate the amount wasted by the environmental forces of photodecomposition, downward migration and washing away by rain. They are also highly toxic to farm workers and expensive on multiple applications which are required because of their lower persistence. On the other hand, the applications of large amounts of persistent herbicides are undesirable because of their frequent incorporation into the food chain. The present invention is capable of obtaining less movement and phytotox migration of the active in low organic soils. The concentration of organic matter in soils generally ranges from 1% to 6% of the total topsoil mass for most upland soils. Soils whose upper horizons consist of less than 1% organic matter are mostly limited to desert or coastal areas, while the organic matter content of soils in low-lying, wet areas can be as high as 90%. Soils containing 12-18% organic matter are generally classified as organic soils The fact that active ingredient product performance can actually be enhanced by reducing downward migration is an important benefit and was unexpectedly discovered by the presently disclosed method. For example, by way of the present method, downward migration of the active is reduced, and this thereby optimizes active ingredient performance. That is, while the contemplated method has beneficial environmental issues and reduces losses of active ingredient in environment, a key aspect is that there is increased performance of the active ingredient itself, particularly in low organic soil conditions.

Methods and compositions to reduce downward migration of herbicides or herbicide downward migration are described herein. The methods and compositions reduce the amount of herbicides leached into soils in both aerial and ground spray applications. The methods include the use of compositions advantageously incorporating one or more active ingredients as particles (preferably microparticles) suspended in water. In alternative embodiments, it may also be possible to utilize one or more polymers, oils, organic compounds, or waxes either together with the oil in water emulsion and/or as an alternative. By solubilizing the active ingredient in a water immicible solvent to form a water in oil emulsion, it is possible to increase the efficiency of pesticides and herbicides. This increases performance of the actives, particularly in low organic conditions, while also potentially allowing lower doses to be used. It would also be possible to include all or part of the active ingredient(s) as a suspension concentrate (“SC”) in an alternate embodiment.

In connection with the present invention it is desirable to employ a formulation where the active ingredient is solubilized in a water-immiscible solvent which creates an oil in water emulsion (“EW”). In an alternative, it is possible to solubilize the active ingredient without water, but to form an emulsifiable concentrate. In a particularly preferred embodiment, indaziflam is included as an active ingredient optionally together with one or more other actives.

The present invention provides a formulation exhibiting advantageous herbicidal efficacy in the preferred soil layer by reducing downward movement of the herbicide. The present formulation is advantageously an oil-in-water emulsion (EW), which includes microscopic droplets of oil containing fully dissolved active ingredient dispersed into the continuous water phase.

EW formulations are water based formulations and are generally preferred in connection with the present invention because they cost less than oil-based formulations, and are often safer to handle and less toxic to mammals and the environment. Emulsifiable concentrates are blends of active ingredient, solvent and one or more emulsifiers which can be added to water.

The composition of an EW formulation generally contains the following: one or more active ingredients, one or more emulsifiers, a solvent that is not miscible with water, one or more antifoam agents, one or more antimicrobial agents, and water. In addition to the above mentioned ingredients, the composition according to the invention may also contain one or more additives preferably soluble either in the water phase or in the solvent phase.

In contrast to EW formulations where the active ingredient is solubilized in water-immiscible solvent, SC formulations include microscopic particles of water-insoluble active ingredients suspended in water.

In one advantageous embodiment, the active ingredient included is Indaziflam. Indaziflam is required to be in its dissolved form before it can act as an herbicide to its environment; the solubility of indaziflam in distilled water is minimal at 0.0028 g/L. The minimal solubility of indaziflam provides residual pre-emergence weed control effect for up to several months as it slowly dissolves in soil upon application.

Indaziflam is also a complex molecule capable of forming Van der Waals, dipole, and hydrogen bonding interactions with other organic compounds it comes in contact with in its dissolved form. However, it is currently believed that upon application of an SC, the vast majority of active ingredient, (ie indaziflam) in the SC formulation remains as solid particles and does not interact with naturally occurring organic matters in the soil. In the absence of chemical interactions, these solid particles of active ingredient then travel downward in the soil toward the root zone of desired plantation, such as turf grass, in the event of rain or irrigation. In which case, since the active ingredient slowly dissolves over time, unwanted herbicidal effect could occur to damage the roots of desired plantation.

Thus, in its dissolved form an active ingredient such as indaziflam could interact with naturally occurring organic matters in the soil. The interaction would hold indaziflam in place and therefore reduce downward movement of the herbicide in the event of rain or irrigation.

The present invention addresses the issue of herbicidal movement in the soil by providing an EW formulation. The formulation provides the active ingredient, advantageously in its fully dissolved form, to enhance its capability of interacting with naturally occurring organic matters in the soil to reduce downward movement of the herbicide upon application. Thus, downward migration will be minimized as much as possible, even in soils with low organic content, ie less than 5%, or less than 4%, or less than 3% or less than 2.5 or 2% organic content, or even less than 1%.

It is also spossible to optionally include one or more additional additives to the EW formulation. Additional additives may serve as intermediaries between the active ingredient and the organic matters in the soil, forming a three-way interaction to further enhance the immobility of the active ingredient in soil.

### Compositions:

Active Ingredient: Active ingredients of the invention can be any pesticide (including but not limited to herbicides, insecticides, fungicides, biocides, etc.) and preferably includes one or more herbicides. Nonlimiting examples of suitable active pesticides are set forth hereinafter. References to herbicides can also refer to any other type of pesticide.

Solvent: The active ingredient(s) of the formulation should be soluble in the solvent, and the solvent should be water immiscible, containing less than 10% water naturally or less than 10% soluble in water. Any suitable solvent can be used, for example butanol, cyclohexanone, dimethylformamide, xylene or else higher-boiling aromatics or hydrocarbons with addition of one or more ionic or nonionic surfactants (emulsifiers). In one embodiment, the solvent is a long chain di-substituted amide. Preferably the active ingredient is completely dissolved in the oil in water emulsion, or 100% dissolved, or at least 99.5% dissolved or 95% dissolved or 90% dissolved.

In preferred embodiments the solvent is one or more of: aromatic hydrocarbons such as SOLVESSO solvents, paraffinic hydrocarbons such as EXXSOL solvent, cyclic hydrocarbons such as cyclohexanone and isophorone, methyl ester solvents such as methyl oleate, methyl palmitate, and methyl laurate (fatty acid based methyl esters) and canola oil or soy oil methyl esters (methylated seed and vegetable oils) and propylene glycol methyl ether, dibasic ester (usually methyl esters) of long chain di-acids ranging from C8-C16 carbon units, amides such long chain primary amides, and disubstituted amides such as C8-C12 dimethyl amides, for example N,N-Dimethyl decanamide, N,N-dimethyl lactamide, N,N-Dimethyl 9-Decenamide and N,N-dimethyl octanamide, glycerol esters such as capric/caprylic triglyceride (triglyceride-based ester), ethoxylated phosphate esters such as nonylphenol POE-10 phosphate ester, acetates such as 2-ethylhexyl acetate and isopropyl acetate, alcohols such as 2-ethylhexanol, octanol, and benzyl alcohol, Lactates such as 2-ethylhexyl lactate and butyl lactate, carbonate esters such as propylene carbonate, diphenyl carbonate, and poly(propylene carbonate), citrates such as acetyl tributyl citrate, triethyl citrate, and n-butylryl tri-n-hexyl citrate, as well as other solvents such as dimethyl sulfoxide, dimethylformamide, and dimethyl isosorbides can also be utilized if desired for any reason.

Emulsifiers: The formulation generally comprises 0.01 to 25% (0.01-15% preferred) by weight of an emulsifier(s). The emulsifier may be any suitable compound of mixture of compounds. Ionic and nonionic emulsifiers can be used.

Suitable Ionic and/or anionic emulsifiers are phosphate esters and sulfate esters such as poly ethoxylated phosphate esters, ethoxylated tridecyl alcohol phosphate esters, ethoxylated fatty alcohol phosphate esters, and sulfate esters of polyethoxylated arylphenols.

Inorganic salts of alkylbenzenesulfonate is another group of examples for anionic emulsifiers such as sodium dodecylbenzene and triethanolamine dodecylbenzene sulfonate.

Examples of nonionic emulsifiers can also be generally from the class of polyethoxylated chemicals, such as ethoxylated alkylphenols, ethoxylated ethanolamides, amine ethoxylates, polyethoxylated castor oils, alcohol ethoxylates, ethoxylated fatty alcohols, ethoxylated castor oil, tridecyl alcohol polyglycol ethers, and ethoxylated tristyrylphenols. Ethoxylated chemicals could be replaced by or be in combination with propoxylated versions.

Other examples of emulsifiers include block copolymers, EO/PO block copolymer, butyl block copolymer, random copolymers and star polymeric surfactant are also desirable in some embodiments.

Polysorbates are another example of emulsifiers, such as polyoxyethylene sorbitan monolaurate, polyoxyethylene sorbitan monooleate, sorbitan monopalmitate and sorbitan monostearate are also optionally included.

Optional Antifoam agent(s): The antiform agent may be any suitable compound or mixture of compounds. Exemplary compounds include Silcolapse 426R or Silcolapse 432 (i.e. polyorganosiloxane aqueous emulsion).

Optional Antimicrobial agent(s): The antimicrobial agent may be any suitable compound or mixture of compounds. Exemplary compounds include Acticide B20 or Acticide SPX (i.e. isothiazolinones) as nonlimting examples. In a particularly advantageous embodiment the optional antimicrobial agent can be any suitable compound or mixture of compounds. for example benzisothiazolinone, isothiazolinones, and bronopols (Acticide B20, Acticide SPX, or Acticide L30).

Optional Additives: Additives in the EW or EC formulation according to the present invention may be water soluble or solvent soluble. Solvent soluble additives can include long chain alcohol molecules. Water soluble additives can include cellulosic materials, polycarboxylates, and cyclic oligosaccharides. Solvent soluble long chain alcohol molecules have previously been described in U.S. Pat. Nos. 5,466,458, 5,527,823, and 6,302,161, which are incorporated by reference in their entireties.

Furthermore as optional additives it is possible to include water soluble or solvent soluble materials. Nonlimiting examples include i). long chain alcohol molecules such as cetyl alcohol and lauryl alcohol; ii). cellulosic materials such as hydroxypropyl methyl cellulose and microfibrillated cellulose; iii). polycarboxylates such as acrylic comb polymer and copolymers of acrylic acid and maleic acid; iv). cyclic oligosaccharides such as alpha-, beta-, and gamma-cyclodextrin; v). dendritic materials such as poly(amidoamine) dendrimers, diaminobutane dendrimers, and polypropylenimine dendrimers; and vi). lignin materials such as kraft lignin and lignosulfonates; vii). polyvinylpyrrolidone materials such as butyl polyvinylpyrrolidone and polyvinylpyrrolidone/hexadecane copolymers.

In one advantageous embodiment, there are included one or more long chain alcohol molecules which form a protective film around each droplet of pesticide which will thereby assist in further reducing herbicidal movement in soil. In particular, long chain alcohol molecules were incorporated as an additive for the EW formulation discussed in the present invention.

Exemplary EW formulations include a suitable active incredient dissolved in a solvent. The solvent phase is dispersed in the continuous water phase with polymeric emulsifier to form an EW formulation. Optional additives to the formulation could include long chain alcohol molecules, cellulosic materials, polycarboxylates, and cyclic oligosaccharides. The formulation also optionally includes one or more antifoam agents and/or antimicrobial agents.

In one particularly preferred embodiment there is provided in weight/weight percentages of a suitable formulation:

An active ingredient, (optionally Indaziflam) can range from 0.1 to 15%, preferably from 0.2 to 10%, preferably from 0.5 to 7%, more preferably from 3 to 7%, a long chain di-substituted amide solvent can range from 10 to 80%, suitably from 12 to 75%, more preferably 15 to 72%, or 17 to 70%, polymeric emulsifiers can range from 0.1 to 15%, suitably from 0.2 to 14%, more preferably from 1 to 10%, additives can range from 0 to 20%, suitably from 0.5 to 15%, more preferably up to 12%, antifoam agent can range from 0 to 20%, suitably from 0.5 to 18%, preferably from 0.9 to 10%, or up to 9%, antimicrobial agent can range from 0 to 20%, suitably from 0.5 to 18%, preferably from 1 to 12% or update to 10%, and water can range from 0 to 80% and advantageously from 0 to 75%, preferably from 0 to 70%. All percentages given by weight, w/w.

In a further aspect, if included, polymers of the present disclosure may include synthetic or natural water-soluble polymers, which are substances that dissolve, disperse or swell in water and, thus, modify the physical properties of aqueous systems in the form of gelation, thickening or emulsification/stabilization. These polymers usually have repeating units or blocks of units; the polymer chains contain hydrophilic groups that are substituents or are incorporated into the backbone. The hydrophilic groups may be nonionic, anionic, cationic or amphoteric.

Exemplary synthetic polymers may include poly(ethylene glycol) (PEG) including PEG-Irinotecan (NKTR-102), PEG-Docetaxel (NKTR-105), PEG-Camptothecin (PROTHECAN or pegamotecan), PEG-SN38 (EZN-2208), polyvinyl pyrrolidone (PVP), polyvinyl alcohol (PVA), polyacrylic acid (PAA), polyacrylamides, N-(2-hydroxypropyl) methacrylamide (HPMA), divinyl ether-maleic anhydride (DIVEMA), polyoxazoline, polyphosphates, and polyphosphazenes. Synthetic polymers may also include graft copolymer of vinylpyrrolidone & butene (Agrimer AL 10), graft copolymer of vinylpyrrolidone and C20 alpha olefin (Agrimer AL 30), crosslinked polyvinylpyrrolidone (Agrimer XL), copolymer of vinylpyrrolidone and acrylic acid (Agrimer AA), copolymer of vinylpyrrolidone and dimethylaminoethylmethacrylate (Agrimer DA 1), terpolymer of vinylpyrrolidone dimethylaminoethylmethacrylate and vinylcaprolactam (Agrimer DAVC), methylvinylether maleic acid alternating copolymer (Agrimer VEMA H240), methylvinylether-monobutylmaleic acid alternating copolymer (Agrimer VEMA ES 425), methylvinylether-monopropylmaleic acid alternating copolymer (Agrimer VEMA ES 335), vinylpyrrolidone vinylacetate copolymer (Agrimer VA 6), poly(methyl vinyl ether/maleic anhydride) (Agrimer VEMA AN-216 VS), polyvinylpyrrolidone/hexadecene copolymer (20/80) (Agrimer AL22), pegylated cross-linked polyphenol, acrylic comb polymer, and poly(vinyl alcohol).

Exemplary natural polymers may include xanthan gum, pectins, chitosan derivatives, dextran, carrageenan, guar gum, cellulose ethers (such as hydroxypropylmethyl cellulose (HPMC), hydroxypropyl cellulose (HPC), hydroxyethyl cellulose (HEC), sodium carboxy methyl cellulose (Na-CMC), sodium CMC, HPC, HPMC), hyaluronic acid (HA), albumin, and starch or starch based derivatives.

In another aspect of the present disclosure, the amount of polymer present in herbicide compositions may range from about 0.1% to about 50%, from about 0.1% to about 45%, from about 0.1% to about 40%, from about 0.1% to about 35%, from about 0.1% to about 30%, from about 0.1% to about 25%, from about 0.1% to about 20%, from about 0.1% to about 15%, from about 0.1% to about 10%, from about 0.1% to about 9%, from about 0.1% to about 8%, from about 0.1% to about 7%, from about 0.1% to about 6%, from about 0.1% to about 5%, from about 0.1% to about 4%, from about 0.1% to about 3.9%, from about 0.1% to about 3.8%, from about 0.1% to about 3.7%, from about 0.1% to about 3.6%, from about 0.1% to about 3.5%, from about 0.1% to about 3.4%, from about 0.1% to about 3.2%, from about 0.1% to about 3.1%, from about 0.1% to about 3%, from about 0.1% to about 2.5%, from about 0.1% to about 2%, from about 0.1% to about 1.5%, from about 0.1% to about 1%, and from about 0.1% to about 0.5%.

In another aspect of the present disclosure, one or more further organic compounds may be included for reducing herbicide downward migration. Suitable nonlimiting examples include humic acid, cyclodextrin, and hydroxypropyl methyl cellulose.

In another aspect of the present disclosure, the amount of organic compounds present in the present compositions may range from about 0.1% to about 70%, from about 0.1% to about 65%, from about 0.1% to about 60%, from about 0.1% to about 55%, from about 0.1% to about 50%, from about 0.1% to about 45%, from about 0.1% to about 40%, from about 0.1% to about 35%, from about 0.1% to about 30%, from about 0.1% to about 25%, from about 0.1% to about 20%, from about 0.1% to about 15%, from about 0.1% to about 10%, from about 0.1% to about 9%, from about 0.1% to about 8%, from about 0.1% to about 7%, from about 0.1% to about 3.8%, from about 0.1% to about 3.7%, from about 0.1% to about 3.6%, from about 0.1% to about 3.5%, from about 0.1% to about 3.4%, from about 0.1% to about 3.2%, from about 0.1% to about 3.1%, from about 0.1% to about 3%, from about 0.1% to about 2.5%, from about 0.1% to about 2%, from about 0.1% to about 1.5%, from about 0.1% to about 1%, and from about 0.1% to about 0.5%.

Suitable active ingredients may be any pesticide and is preferably one or more herbicide. In one particularly preferred embodiment, the herbicide employed is a selective pre-emergence (PRE) alkylazine herbicide that inhibits cellulose biosynthesis in susceptible species. The preferred herbicide should preferably be useable for example, in commercial nurseries, commercial/residential lawns, forestry sites, golf courses, highway rights-of-way, landscape plantings, ornamentals, sod farms, and sports fields. A preferred herbicide should optionally control many monocotyledonous and dicotyledonous weeds including annual bluegrass (Poa annua L.), crabgrass (Digitaria spp.), goosegrass [Eleusine indica (L.) Gaertn.], lawn burweed (Soliva sessilis Ruiz & Pay.), and yellow woodsorrel (Oxalis stricta L.). Additionally, indaziflam provides an alternative mode of action for PRE control of dinitroaniline-resistant annual grassy weeds in the southern United States. A suitable herbicide should advantageously be useful for application, for example to warm season turfgrasses including bahiagrass (Paspalum notatum Fluegge), buffalograss [Bouteloua dactyloides (Nutt.) J. T. Columbus], centipedegrass [Eremochloa ophiuroides (Munro) Hack.], common bermudagrass [Cynodon dactylon (L.) Pers.], hybrid bermudagrass, St. Augustinegrass [Stenotaphrum secundatum (Walt.) Ktze.], and zoysiagrass (Zoysia spp.).

Suitable herbicides used in the present disclosure may include in one preferred embodiment indaziflam. Other possible pesticides that can be used singly or in combination include for example, (3-ethoxypropyl)mercury bromide, 1,2-dichloropropane, 1,3-dichloropropene, 1-methylcyclopropene, 1-naphthol, 2-(octylthio)ethanol, 2,3,5-tri-iodobenzoic acid, 2,3,6-TBA, 2,3,6-TBA-dimethylammonium, 2,3,6-TBA-lithium, 2,3,6-TBA-potassium, 2,3,6-TBA-sodium, 2,4,5-T, 2,4,5-T-2-butoxypropyl, 2,4,5-T-2-ethylhexyl, 2,4,5-T-3-butoxypropyl, 2,4,5-TB, 2,4,5-T-butometyl, 2,4,5-T-butotyl, 2,4,5-T-butyl, 2,4,5-T-isobutyl, 2,4,5-T-isoctyl, 2,4,5-T-isopropyl, 2,4,5-T-methyl, 2,4,5-T-pentyl, 2,4,5-T-sodium, 2,4,5-T-triethylammonium, 2,4,5-T-trolamine, 2,4-D, 2,4-D-2-butoxypropyl, 2,4-D-2-ethylhexyl, 2,4-D-3-butoxypropyl, 2,4-D-ammonium, 2,4-DB, 2,4-DB -butyl, 2,4-DB -dimethylammonium, 2,4-DB -isoctyl, 2,4-DB-potassium, 2,4-DB-sodium, 2,4-D-butotyl, 2,4-D-butyl, 2,4-D-diethylammonium, 2,4-D-dimethylammonium, 2,4-D-diolamine, 2,4-D-dodecylammonium, 2,4-DEB, 2,4-DEP, 2,4-D-ethyl, 2,4-D-heptylammonium, 2,4-D-isobutyl, 2,4-D-isoctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-potassium, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 2iP, 2-methoxyethylmercury chloride, 2-phenylphenol, 3,4-DA, 3,4-DB, 3,4-DP, 4-aminopyridine, 4-CPA, 4-CPA-potassium, 4-CPA-sodium, 4-CPB, 4-CPP, 4-hydroxyphenethyl alcohol, 8-hydroxyquinoline sulfate, 8-phenylmercurioxyquinoline, abamectin, abscisic acid, ACC, acephate, acequinocyl, acetamiprid, acethion, acetochlor, acetophos, acetoprole, acibenzolar, acibenzolar-S-methyl, acifluorfen, acifluorfen-methyl, acifluorfen-sodium, aclonifen, acrep, acrinathrin, acrolein, acrylonitrile, acypetacs, acypetacs-copper, acypetacs-zinc, alachlor, alanycarb, albendazole, aldicarb, aldimorph, aldoxycarb, aldrin, allethrin, allicin, allidochlor, allosamidin, alloxydim, alloxydim-sodium, allyl alcohol, allyxycarb, alorac, alpha-cypermethrin, alpha-endosulfan, ametoctradin, ametridione, ametryn, amibuzin, amicarbazone, amicarthiazol, amidithion, amidoflumet, amidosulfuron, aminocarb, aminocyclopyrachlor, aminocyclopyrachlor-methyl, aminocyclopyrachlor-potassium, aminopyralid, aminopyralid-potassium, aminopyralid-tris(2-hydroxypropyl)ammonium, amiprofos-methyl, amiprophos, amisulbrom, amiton, amiton oxalate, amitraz, amitrole, ammonium sulfamate, ammonium α-naphthaleneacetate, amobam, ampropylfos, anabasine, ancymidol, anilazine, anilofos, anisuron, anthraquinone, antu, apholate, aramite, arsenous oxide, asomate, aspirin, asulam, asulam-potassium, asulam-sodium, athidathion, atraton, atrazine, aureofungin, aviglycine, aviglycine hydrochloride, azaconazole, azadirachtin, azafenidin, azamethiphos, azimsulfuron, azinphos-ethyl, azinphos-methyl, aziprotryne, azithiram, azobenzene, azocyclotin, azothoate, azoxystrobin, bachmedesh, barban, barium hexafluorosilicate, barium polysulfide, barthrin, BCPC, beflubutamid, benalaxyl, benalaxyl-M, benazolin, benazolin-dimethylammonium, benazolin-ethyl, benazolin-potassium, bencarbazone, benclothiaz, bendiocarb, benfluralin, benfuracarb, benfuresate, benodanil, benomyl, benoxacor, benoxafos, benquinox, bensulfuron, bensulfuron-methyl, bensulide, bensultap, bentaluron, bentazone, bentazone-sodium, benthiavalicarb, benthiavalicarb-isopropyl, benthiazole, bentranil, benzadox, benzadox-ammonium, benzalkonium chloride, benzamacril, benzamacril-isobutyl, benzamorf, benzfendizone, benzipram, benzobicyclon, benzofenap, benzofluor, benzohydroxamic acid, benzoximate, benzoylprop, benzoylprop-ethyl, benzthiazuron, benzyl benzoate, benzyladenine, berberine, berberine chloride, beta-cyfluthrin, beta-cypermethrin, bethoxazin, bicyclopyrone, bifenazate, bifenox, bifenthrin, bifujunzhi, bilanafos, bilanafos-sodium, binapacryl, bingqingxiao, bioallethrin, bioethanomethrin, biopermethrin, bioresmethrin, biphenyl, bisazir, bismerthiazol, bispyribac, bispyribac-sodium, bistrifluron, bitertanol, bithionol, bixafen, blasticidin-S, borax, Bordeaux mixture, boric acid, boscalid, brassinolide, brassinolide-ethyl, brevicomin, brodifacoum, brofenvalerate, brofluthrinate, bromacil, bromacil-lithium, bromacil-sodium, bromadiolone, bromethalin, bromethrin, bromfenvinfos, bromoacetamide, bromobonil, bromobutide, bromocyclen, bromo-DDT, bromofenoxim, bromophos, bromophos-ethyl, bromopropylate, bromothalonil, bromoxynil, bromoxynil butyrate, bromoxynil heptanoate, bromoxynil octanoate, bromoxynil-potassium, brompyrazon, bromuconazole, bronopol, bucarpolate, bufencarb, buminafos, bupirimate, buprofezin, Burgundy mixture, busulfan, butacarb, butachlor, butafenacil, butamifos, butathiofos, butenachlor, butethrin, buthidazole, buthiobate, buthiuron, butocarboxim, butonate, butopyronoxyl, butoxycarboxim, butralin, butroxydim, buturon, butylamine, butylate, cacodylic acid, cadusafos, cafenstrole, calcium arsenate, calcium chlorate, calcium cyanamide, calcium polysulfide, calvinphos, cambendichlor, camphechlor, camphor, captafol, captan, carbamorph, carbanolate, carbaryl, carbasulam, carbendazim, carbendazim benzenesulfonate, carbendazim sulfite, carbetamide, carbofuran, carbon disulfide, carbon tetrachloride, carbophenothion, carbosulfan, carboxazole, carboxide, carboxin, carfentrazone, carfentrazone-ethyl, carpropamid, cartap, cartap hydrochloride, carvacrol, carvone, CDEA, cellocidin, CEPC, ceralure, Cheshunt mixture, chinomethionat, chitosan, chlobenthiazone, chlomethoxyfen, chloralose, chloramben, chloramben-ammonium, chloramben-diolamine, chloramben-methyl, chloramben-methylammonium, chloramben-sodium, chloramine phosphorus, chloramphenicol, chloraniformethan, chloranil, chloranocryl, chlorantraniliprole, chlorazifop, chlorazifop-propargyl, chlorazine, chlorbenside, chlorbenzuron, chlorbicyclen, chlorbromuron, chlorbufam, chlordane, chlordecone, chlordimeform, chlordimeform hydrochloride, chlorempenthrin, chlorethoxyfos, chloreturon, chlorfenac, chlorfenac-ammonium, chlorfenac-sodium, chlorfenapyr, chlorfenazole, chlorfenethol, chlorfenprop, chlorfenson, chlorfensulphide, chlorfenvinphos, chlorfluazuron, chlorflurazole, chlorfluren, chlorfluren-methyl, chlorflurenol, chlorflurenol-methyl, chloridazon, chlorimuron, chlorimuron-ethyl, chlormephos, chlormequat, chlormequat chloride, chlornidine, chlornitrofen, chlorobenzilate, chlorodinitronaphthalenes, chloroform, chloromebuform, chloromethiuron, chloroneb, chlorophacinone, chlorophacinone-sodium, chloropicrin, chloropon, chloropropylate, chlorothalonil, chlorotoluron, chloroxuron, chloroxynil, chlorphonium, chlorphonium chloride, chlorphoxim, chlorprazophos, chlorprocarb, chlorpropham, chlorpyrifos, chlorpyrifos-methyl, chlorquinox, chlorsulfuron, chlorthal, chlorthal-dimethyl, chlorthal-monomethyl, chlorthiamid, chlorthiophos, chlozolinate, choline chloride, chromafenozide, cinerin I, cinerin II, cinerins, cinidon-ethyl, cinmethylin, cinosulfuron, ciobutide, cisanilide, cismethrin, clethodim, climbazole, cliodinate, clodinafop, clodinafop-propargyl, cloethocarb, clofencet, clofencet-potassium, clofentezine, clofibric acid, clofop, clofop-isobutyl, clomazone, clomeprop, cloprop, cloproxydim, clopyralid, clopyralid-methyl, clopyralid-olamine, clopyralid-potassium, clopyralid-tris(2-hydroxypropyl)ammonium, cloquintocet, cloquintocet-mexyl, cloransulam, cloransulam-methyl, closantel, clothianidin, clotrimazole, cloxyfonac, cloxyfonac-sodium, CMA, codlelure, colophonate, copper acetate, copper acetoarsenite, copper arsenate, copper carbonate, basic, copper hydroxide, copper naphthenate, copper oleate, copper oxychloride, copper silicate, copper sulfate, copper zinc chromate, coumachlor, coumafuryl, coumaphos, coumatetralyl, coumithoate, coumoxystrobin, CPMC, CPMF, CPPC, credazine, cresol, crimidine, crotamiton, crotoxyphos, crufomate, cryolite, cue-lure, cufraneb, cumyluron, cuprobam, cuprous oxide, curcumenol, cyanamide, cyanatryn, cyanazine, cyanofenphos, cyanophos, cyanthoate, cyantraniliprole, cyazofamid, cybutryne, cyclafuramid, cyclanilide, cyclethrin, cycloate, cycloheximide, cycloprate, cycloprothrin, cyclosulfamuron, cycloxydim, cycluron, cyenopyrafen, cyflufenamid, cyflumetofen, cyfluthrin, cyhalofop, cyhalofop-butyl, cyhalothrin, cyhexatin, cymiazole, cymiazole hydrochloride, cymoxanil, cyometrinil, cypendazole, cypermethrin, cyperquat, cyperquat chloride, cyphenothrin, cyprazine, cyprazole, cyproconazole, cyprodinil, cyprofuram, cypromid, cyprosulfamide, cyromazine, cythioate, daimuron, dalapon, dalapon-calcium, dalapon-magnesium, dalapon-sodium, daminozide, dayoutong, dazomet, dazomet-sodium, DBCP, d-camphor, DCIP, DCPTA, DDT, debacarb, decafentin, decarbofuran, dehydroacetic acid, delachlor, deltamethrin, demephion, demephion-O, demephion-S, demeton, demeton-methyl, demeton-O, demeton-O-methyl, demeton-S, demeton-S-methyl, demeton-S-methylsulphon, desmedipham, desmetryn, d-fanshiluquebingjuzhi, diafenthiuron, dialifos, di-allate, diamidafos, diatomaceous earth, diazinon, dibutyl phthalate, dibutyl succinate, dicamba, dicamba-diglycolamine, dicamba-dimethylammonium, dicamba-diolamine, dicamba-isopropylammonium, dicamba-methyl, dicamba-olamine, dicamba-potassium, dicamba-sodium, dicamba-trolamine, dicapthon, dichlobenil, dichlofenthion, dichlofluanid, dichlone, dichloralurea, dichlorbenzuron, dichlorflurenol, dichlorflurenol-methyl, dichlormate, dichlormid, dichlorophen, dichlorprop, dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P-2-ethylhexyl, dichlorprop-P-dimethylammonium, dichlorprop-potassium, dichlorprop-sodium, dichlorvos, dichlozoline, diclobutrazol, diclocymet, diclofop, diclofop-methyl, diclomezine, diclomezine-sodium, dicloran, diclosulam, dicofol, dicoumarol, dicresyl, dicrotophos, dicyclanil, dicyclonon, dieldrin, dienochlor, diethamquat, diethamquat dichloride, diethatyl, diethatyl-ethyl, diethofencarb, dietholate, diethyl pyrocarbonate, diethyltoluamide, difenacoum, difenoconazole, difenopenten, difenopenten-ethyl, difenoxuron, difenzoquat, difenzoquat metilsulfate, difethialone, diflovidazin, diflubenzuron, diflufenican, diflufenzopyr, diflufenzopyr-sodium, diflumetorim, dikegulac, dikegulac-sodium, dilor, dimatif, dimefluthrin, dimefox, dimefuron, dimepiperate, dimetachlone, dimetan, dimethacarb, dimethachlor, dimethametryn, dimethenamid, dimethenamid-P, dimethipin, dimethirimol, dimethoate, dimethomorph, dimethrin, dimethyl carbate, dimethyl phthalate, dimethylvinphos, dimetilan, dimexano, dimidazon, dimoxystrobin, dinex, dinex-diclexine, dingjunezuo, diniconazole, diniconazole-M, dinitramine, dinobuton, dinocap, dinocap-4, dinocap-6, dinocton, dinofenate, dinopenton, dinoprop, dinosam, dinoseb, dinoseb acetate, dinoseb-ammonium, dinoseb-diolamine, dinoseb-sodium, dinoseb-trolamine, dinosulfon, dinotefuran, dinoterb, dinoterb acetate, dinoterbon, diofenolan, dioxabenzofos, dioxacarb, dioxathion, diphacinone, diphacinone-sodium, diphenamid, diphenyl sulfone, diphenylamine, dipropalin, dipropetryn, dipyrithione, diquat, diquat dibromide, disparlure, disul, disulfiram, disulfoton, disul-sodium, ditalimfos, dithianon, dithicrofos, dithioether, dithiopyr, diuron, d-limonene, DMPA, DNOC, DNOC-ammonium, DNOC-potassium, DNOC-sodium, dodemorph, dodemorph acetate, dodemorph benzoate, dodicin, dodicin hydrochloride, dodicin-sodium, dodine, dofenapyn, dominicalure, doramectin, drazoxolon, DSMA, dufulin, EBEP, EBP, ecdysterone, edifenphos, eglinazine, eglinazine-ethyl, emamectin, emamectin benzoate, EMPC, empenthrin, endosulfan, endothal, endothal-diammonium, endothal-dipotassium, endothal-disodium, endothion, endrin, enestroburin, EPN, epocholeone, epofenonane, epoxiconazole, eprinomectin, epronaz, EPTC, erbon, ergocalciferol, erlujixiancaoan, esdépalléthrine, esfenvalerate, esprocarb, etacelasil, etaconazole, etaphos, etem, ethaboxam, ethachlor, ethalfluralin, ethametsulfuron, ethametsulfuron-methyl, ethaprochlor, ethephon, ethidimuron, ethiofencarb, ethiolate, ethion, ethiozin, ethiprole, ethirimol, ethoate-methyl, ethofumesate, ethohexadiol, ethoprophos, ethoxyfen, ethoxyfen-ethyl, ethoxyquin, ethoxysulfuron, ethychlozate, ethyl formate, ethyl α-naphthaleneacetate, ethyl-DDD, ethylene, ethylene dibromide, ethylene dichloride, ethylene oxide, ethylicin, ethylmercury 2,3-dihydroxypropyl mercaptide, ethylmercury acetate, ethylmercury bromide, ethylmercury chloride, ethylmercury phosphate, etinofen, etnipromid, etobenzanid, etofenprox, etoxazole, etridiazole, etrimfos, eugenol, EXD, famoxadone, famphur, fenamidone, fenaminosulf, fenamiphos, fenapanil, fenarimol, fenasulam, fenazaflor, fenazaquin, fenbuconazole, fenbutatin oxide, fenchlorazole, fenchlorazole-ethyl, fenchlorphos, fenclorim, fenethacarb, fenfluthrin, fenfuram, fenhexamid, fenitropan, fenitrothion, fenjuntong, fenobucarb, fenoprop, fenoprop-3-butoxypropyl, fenoprop-butometyl, fenoprop-butotyl, fenoprop-butyl, fenoprop-isoctyl, fenoprop-methyl, fenoprop-potassium, fenothiocarb, fenoxacrim, fenoxanil, fenoxaprop, fenoxaprop-ethyl, fenoxaprop-P, fenoxaprop-P-ethyl, fenoxasulfone, fenoxycarb, fenpiclonil, fenpirithrin, fenpropathrin, fenpropidin, fenpropimorph, fenpyrazamine, fenpyroximate, fenridazon, fenridazon-potassium, fenridazon-propyl, fenson, fensulfothion, fenteracol, fenthiaprop, fenthiaprop-ethyl, fenthion, fenthion-ethyl, fentin, fentin acetate, fentin chloride, fentin hydroxide, fentrazamide, fentrifanil, fenuron, fenuron TCA, fenvalerate, ferbam, ferimzone, ferrous sulfate, fipronil, flamprop, flamprop-isopropyl, flamprop-M, flamprop-methyl, flamprop-M-isopropyl, flamprop-M-methyl, flazasulfuron, flocoumafen, flometoquin, flonicamid, florapyrauxifen, florasulam, fluacrypyrim, fluazifop, fluazifop-butyl, fluazifop-methyl, fluazifop-P, fluazifop-P-butyl, fluazinam, fluazolate, fluazuron, flubendiamide, flubenzimine, flucarbazone, flucarbazone-sodium, flucetosulfuron, fluchloralin, flucofuron, flucycloxuron, flucythrinate, fludioxonil, fluenetil, fluensulfone, flufenacet, flufenerim, flufenican, flufenoxuron, flufenprox, flufenpyr, flufenpyr-ethyl, flufiprole, flumethrin, flumetover, flumetralin, flumetsulam, flumezin, flumiclorac, flumiclorac-pentyl, flumioxazin, flumipropyn, flumorph, fluometuron, fluopicolide, fluopyram, fluorbenside, fluoridamid, fluoroacetamide, fluorodifen, fluoroglycofen, fluoroglycofen-ethyl, fluoroimide, fluoromidine, fluoronitrofen, fluothiuron, fluotrimazole, fluoxastrobin, flupoxam, flupropacil, flupropadine, flupropanate, flupropanate-sodium, flupyradifurone, flupyrsulfuron, flupyrsulfuron-methyl, flupyrsulfuron-methyl-sodium, fluquinconazole, flurazole, flurenol, flurenol-butyl, flurenol-methyl, fluridone, flurochloridone, fluroxypyr, fluroxypyr-butometyl, fluroxypyr-meptyl, flurprimidol, flursulamid, flurtamone, flusilazole, flusulfamide, fluthiacet, fluthiacet-methyl, flutianil, flutolanil, flutriafol, fluvalinate, fluxapyroxad, fluxofenim, folpet, fomesafen, fomesafen-sodium, fonofos, foramsulfuron, forchlorfenuron, formaldehyde, formetanate, formetanate hydrochloride, formothion, formparanate, formparanate hydrochloride, fosamine, fosamine-ammonium, fosetyl, fosetyl-aluminium, fosmethilan, fospirate, fosthiazate, fosthietan, frontalin, fuberidazole, fucaojing, fucaomi, funaihecaoling, fuphenthiourea, furalane, furalaxyl, furamethrin, furametpyr, furathiocarb, furcarbanil, furconazole, furconazole-cis, furethrin, furfural, furilazole, furmecyclox, furophanate, furyloxyfen, gamma-cyhalothrin, gamma-HCH, genit, gibberellic acid, gibberellins, gliftor, glufosinate, glufosinate-ammonium, glufosinate-P, glufosinate-P-ammonium, glufosinate-P-sodium, glyodin, glyoxime, glyphosate, glyphosate-diammonium, glyphosate-dimethylammonium, glyphosate-isopropylammonium, glyphosate-monoammonium, glyphosate-potassium, glyphosate-sesquisodium, glyphosate-trimesium, glyphosine, gos syplure, grandlure, griseofulvin, guazatine, guazatine acetates, halacrinate, halauxifen, halfenprox, halofenozide, halosafen, halosulfuron, halosulfuron-methyl, haloxydine, haloxyfop, haloxyfop-etotyl, haloxyfop-methyl, haloxyfop-P, haloxyfop-P-etotyl, haloxyfop-P-methyl, haloxyfop-sodium, HCH, hemel, hempa, HEOD, heptachlor, heptenophos, heptopargil, heterophos, hexachloroacetone, hexachlorobenzene, hexachlorobutadiene, hexachlorophene, hexaconazole, hexaflumuron, hexaflurate, hexalure, hexamide, hexazinone, hexylthiofos, hexythiazox, HHDN, holosulf, huancaiwo, huangcaoling, huanjunzuo, hydramethylnon, hydrargaphen, hydrated lime, hydrogen cyanide, hydroprene, hymexazol, hyquincarb, IAA, IBA, icaridin, imazalil, imazalil nitrate, imazalil sulfate, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazaquin-methyl, imazaquin-sodium, imazethapyr, imazethapyr-ammonium, imazosulfuron, imibenconazole, imicyafos, imidacloprid, imidaclothiz, iminoctadine, iminoctadine triacetate, iminoctadine trialbesilate, imiprothrin, inabenfide, indanofan, indaziflam, indoxacarb, inezin, iodobonil, iodocarb, iodomethane, iodosulfuron, iodosulfuron-methyl, iodosulfuron-methyl-sodium, iofensulfuron, iofensulfuron-sodium, ioxynil, ioxynil octanoate, ioxynil-lithium, ioxynil-sodium, ipazine, ipconazole, ipfencarbazone, iprobenfos, iprodione, iprovalicarb, iprymidam, ipsdienol, ipsenol, IPSP, isamidofos, isazofos, isobenzan, isocarbamid, isocarbophos, isocil, isodrin, isofenphos, isofenphos-methyl, isolan, isomethiozin, isonoruron, isopolinate, isoprocarb, isopropalin, isoprothiolane, isoproturon, isopyrazam, isopyrimol, isothioate, isotianil, isouron, isovaledione, isoxaben, isoxachlortole, isoxadifen, isoxadifen-ethyl, isoxaflutole, isoxapyrifop, isoxathion, ivermectin, izopamfos, japonilure, japothrins, jasmolin I, jasmolin II, jasmonic acid, jiahuangchongzong, jiajizengxiaolin, jiaxiangjunzhi, jiecaowan, jiecaoxi, jodfenphos, juvenile hormone I, juvenile hormone II, juvenile hormone III, kadethrin, karbutilate, karetazan, karetazan-potassium, kasugamycin, kasugamycin hydrochloride, kejunlin, kelevan, ketospiradox, ketospiradox-potassium, kinetin, kinoprene, kresoxim-methyl, kuicaoxi, lactofen, lambda-cyhalothrin, latilure, lead arsenate, lenacil, lepimectin, leptophos, lindane, lineatin, linuron, lirimfos, litlure, looplure, lufenuron, lvdingjunzhi, Ivxiancaolin, lythidathion, MAA, malathion, maleic hydrazide, malonoben, maltodextrin, MAMA, mancopper, mancozeb, mandipropamid, maneb, matrine, mazidox, MCPA, MCPA-2-ethylhexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-potassium, MCPA-sodium, MCPA-thioethyl, MCPA-trolamine, MCPB, MCPB-ethyl, MCPB-methyl, MCPB-sodium, mebenil, mecarbam, mecarbinzid, mecarphon, mecoprop, mecoprop-2-ethylhexyl, mecoprop-dimethylammonium, mecoprop-diolamine, mecoprop-ethadyl, mecoprop-isoctyl, mecoprop-methyl, mecoprop-P, mecoprop-P-2-ethylhexyl, mecoprop-P-dimethylammonium, mecoprop-P-isobutyl, mecoprop-potassium, mecoprop-P-potassium, mecoprop-sodium, mecoprop-trolamine, medimeform, medinoterb, medinoterb acetate, medlure, mefenacet, mefenpyr, mefenpyr-diethyl, mefluidide, mefluidide-diolamine, mefluidide-potassium, megatomoic acid, menazon, mepanipyrim, meperfluthrin, mephenate, mephosfolan, mepiquat, mepiquat chloride, mepiquat pentaborate, mepronil, meptyldinocap, mercuric chloride, mercuric oxide, mercurous chloride, merphos, mesoprazine, mesosulfuron, mesosulfuron-methyl, mesotrione, mesulfen, mesulfenfos, metaflumizone, metalaxyl, metalaxyl-M, metaldehyde, metam, metam-ammonium, metamifop, metamitron, metam-potassium, metam-sodium, metazachlor, metazosulfuron, metazoxolon, metconazole, metepa, metflurazon, methabenzthiazuron, methacrifos, methalpropalin, methamidophos, methasulfocarb, methazole, methfuroxam, methidathion, methiobencarb, methiocarb, methiopyrisulfuron, methiotepa, methiozolin, methiuron, methocrotophos, methometon, methomyl, methoprene, methoprotryne, methoquin-butyl, methothrin, methoxychlor, methoxyfenozide, methoxyphenone, methyl apholate, methyl bromide, methyl eugenol, methyl iodide, methyl isothiocyanate, methylacetophos, methylchloroform, methyldymron, methylene chloride, methylmercury benzoate, methylmercury dicyandiamide, methylmercury pentachlorophenoxide, methylneodecanamide, metiram, metobenzuron, metobromuron, metofluthrin, metolachlor, metolcarb, metominostrobin, metosulam, metoxadiazone, metoxuron, metrafenone, metribuzin, metsulfovax, metsulfuron, metsulfuron-methyl, mevinphos, mexacarbate, mieshuan, milbemectin, milbemycin oxime, milneb, mipafox, mirex, MNAF, moguchun, molinate, molosultap, monalide, monisouron, monochloroacetic acid, monocrotophos, monolinuron, monosulfuron, monosulfuron-ester, monuron, monuron TCA, morfamquat, morfamquat dichloride, moroxydine, moroxydine hydrochloride, morphothion, morzid, moxidectin, MSMA, muscalure, myclobutanil, myclozolin, N-(ethylmercury)-p-toluenesulphonanilide, nabam, naftalofos, naled, naphthalene, naphthaleneacetamide, naphthalic anhydride, naphthoxyacetic acids, naproanilide, napropamide, naptalam, naptalam-sodium, natamycin, neburon, niclosamide, niclosamide-olamine, nicosulfuron, nicotine, nifluridide, nipyraclofen, nitenpyram, nithiazine, nitralin, nitrapyrin, nitrilacarb, nitrofen, nitrofluorfen, nitrostyrene, nitrothal-isopropyl, norbormide, norflurazon, nornicotine, noruron, novaluron, noviflumuron, nuarimol, OCH, octachlorodipropyl ether, octhilinone, ofurace, omethoate, orbencarb, orfralure, ortho-dichlorobenzene, orthosulfamuron, oryctalure, orysastrobin, oryzalin, osthol, ostramone, oxabetrinil, oxadiargyl, oxadiazon, oxadixyl, oxamate, oxamyl, oxapyrazon, oxapyrazon-dimolamine, oxapyrazon-sodium, oxasulfuron, oxaziclomefone, oxine-copper, oxolinic acid, oxpoconazole, oxpoconazole fumarate, oxycarboxin, oxydemeton-methyl, oxydeprofos, oxydisulfoton, oxyfluorfen, oxymatrine, oxytetracycline, oxytetracycline hydrochloride, paclobutrazol, paichongding, para-dichlorobenzene, parafluron, paraquat, paraquat dichloride, paraquat dimetilsulfate, parathion, parathion-methyl, parinol, pebulate, pefurazoate, pelargonic acid, penconazole, pencycuron, pendimethalin, penflufen, penfluron, penoxsulam, pentachlorophenol, pentanochlor, penthiopyrad, pentmethrin, pentoxazone, perfluidone, permethrin, pethoxamid, phenamacril, phenazine oxide, phenisopham, phenkapton, phenmedipham, phenmedipham-ethyl, phenobenzuron, phenothrin, phenproxide, phenthoate, phenylmercuriurea, phenylmercury acetate, phenylmercury chloride, phenylmercury derivative of pyrocatechol, phenylmercury nitrate, phenylmercury salicylate, phorate, phosacetim, phosalone, phosdiphen, phosfolan, phosfolan-methyl, phosglycin, phosmet, phosnichlor, phosphamidon, phosphine, phosphocarb, phosphorus, phostin, phoxim, phoxim-methyl, phthalide, picloram, picloram-2-ethylhexyl, picloram-isoctyl, picloram-methyl, picloram-olamine, picloram-potassium, picloram-triethylammonium, picloram-tris(2-hydroxypropyl)ammonium, picolinafen, picoxystrobin, pindone, pindone-sodium, pinoxaden, piperalin, piperonyl butoxide, piperonyl cyclonene, piperophos, piproctanyl, piproctanyl bromide, piprotal, pirimetaphos, pirimicarb, pirimioxyphos, pirimiphos-ethyl, pirimiphos-methyl, plifenate, polycarbamate, polyoxins, polyoxorim, polyoxorim-zinc, polythialan, potassium arsenite, potassium azide, potassium cyanate, potassium gibberellate, potassium naphthenate, potassium polysulfide, potassium thiocyanate, potassium α-naphthaleneacetate, pp′-DDT, prallethrin, precocene I, precocene II, precocene III, pretilachlor, primidophos, primisulfuron, primisulfuron-methyl, probenazole, prochloraz, prochloraz-manganese, proclonol, procyazine, procymidone, prodiamine, profenofos, profluazol, profluralin, profluthrin, profoxydim, proglinazine, proglinazine-ethyl, prohexadione, prohexadione-calcium, prohydrojasmon, promacyl, promecarb, prometon, prometryn, promurit, propachlor, propamidine, propamidine dihydrochloride, propamocarb, propamocarb hydrochloride, propanil, propaphos, propaquizafop, propargite, proparthrin, propazine, propetamphos, propham, propiconazole, propineb, propisochlor, propoxur, propoxycarbazone, propoxycarbazone-sodium, propyl isome, propyrisulfuron, propyzamide, proquinazid, prosuler, prosulfalin, prosulfocarb, prosulfuron, prothidathion, prothiocarb, prothiocarb hydrochloride, prothioconazole, prothiofos, prothoate, protrifenbute, proxan, proxan-sodium, prynachlor, pydanon, pymetrozine, pyracarbolid, pyraclofos, pyraclonil, pyraclostrobin, pyraflufen, pyraflufen-ethyl, pyrafluprole, pyramat, pyrametostrobin, pyraoxystrobin, pyrasulfotole, pyrazolynate, pyrazophos, pyrazosulfuron, pyrazosulfuron-ethyl, pyrazothion, pyrazoxyfen, pyresmethrin, pyrethrin I, pyrethrin II, pyrethrins, pyribambenz-isopropyl, pyribambenz-propyl, pyribencarb, pyribenzoxim, pyributicarb, pyriclor, pyridaben, pyridafol, pyridalyl, pyridaphenthion, pyridate, pyridinitril, pyrifenox, pyrifluquinazon, pyriftalid, pyrimethanil, pyrimidifen, pyriminobac, pyriminobac-methyl, pyrimisulfan, pyrimitate, pyrinuron, pyriofenone, pyriprole, pyripropanol, pyriproxyfen, pyrithiobac, pyrithiobac-sodium, pyrolan, pyroquilon, pyroxasulfone, pyroxsulam, pyroxychlor, pyroxyfur, quassia, quinacetol, quinacetol sulfate, quinalphos, quinalphos-methyl, quinazamid, quinclorac, quinconazole, quinmerac, quinoclamine, quinonamid, quinothion, quinoxyfen, quintiofos, quintozene, quizalofop, quizalofop-ethyl, quizalofop-P, quizalofop-P-ethyl, quizalofop-P-tefuryl, quwenzhi, quyingding, rabenzazole, rafoxanide, rebemide, resmethrin, rhodethanil, rhodojaponin-III, ribavirin, rimsulfuron, rotenone, ryania, saflufenacil, saijunmao, saisentong, salicylanilide, sanguinarine, santonin, schradan, scilliroside, sebuthylazine, secbumeton, sedaxane, selamectin, semiamitraz, semiamitraz chloride, sesamex, sesamolin, sethoxydim, shuangjiaancaolin, siduron, siglure, silafluofen, silatrane, silica gel, silthiofam, simazine, simeconazole, simeton, simetryn, sintofen, SMA, S-metolachlor, sodium arsenite, sodium azide, sodium chlorate, sodium fluoride, sodium fluoroacetate, sodium hexafluorosilicate, sodium naphthenate, sodium orthophenylphenoxide, sodium pentachlorophenoxide, sodium polysulfide, sodium thiocyanate, sodium α-naphthaleneacetate, sophamide, spinetoram, spinosad, spirodiclofen, spiromesifen, spirotetramat, spiroxamine, streptomycin, streptomycin sesquisulfate, strychnine, sulcatol, sulcofuron, sulcofuron-sodium, sulcotrione, sulfallate, sulfentrazone, sulfiram, sulfluramid, sulfometuron, sulfometuron-methyl, sulfosulfuron, sulfotep, sulfoxaflor, sulfoxide, sulfoxime, sulfur, sulfuric acid, sulfuryl fluoride, sulglycapin, sulprofos, sultropen, swep, tau-fluvalinate, tavron, tazimcarb, TCA, TCA-ammonium, TCA-calcium, TCA-ethadyl, TCA-magnesium, TCA-sodium, TDE, tebuconazole, tebufenozide, tebufenpyrad, tebufloquin, tebupirimfos, tebutam, tebuthiuron, tecloftalam, tecnazene, tecoram, teflubenzuron, tefluthrin, tefuryltrione, tembotrione, temephos, tepa, TEPP, tepraloxydim, terallethrin, terbacil, terbucarb, terbuchlor, terbufos, terbumeton, terbuthylazine, terbutryn, tetcyclacis, tetrachloroethane, tetrachlorvinphos, tetraconazole, tetradifon, tetrafluron, tetramethrin, tetramethylfluthrin, tetramine, tetranactin, tetrasul, thallium sulfate, thenylchlor, theta-cypermethrin, thiabendazole, thiacloprid, thiadifluor, thiamethoxam, thiapronil, thiazafluron, thiazopyr, thicrofos, thicyofen, thidiazimin, thidiazuron, thiencarbazone, thiencarbazone-methyl, thifensulfuron, thifensulfuron-methyl, thifluzamide, thiobencarb, thiocarboxime, thiochlorfenphim, thiocyclam, thiocyclam hydrochloride, thiocyclam oxalate, thiodiazole-copper, thiodicarb, thiofanox, thiofluoximate, thiohempa, thiomersal, thiometon, thionazin, thiophanate, thiophanate-methyl, thioquinox, thiosemicarbazide, thiosultap, thiosultap-diammonium, thiosultap-disodium, thiosultap-monosodium, thiotepa, thiram, thuringiensin, tiadinil, tiaojiean, tiocarbazil, tioclorim, tioxymid, tirpate, tolclofos-methyl, tolfenpyrad, tolylfluanid, tolylmercury acetate, topramezone, tralkoxydim, tralocythrin, tralomethrin, tralopyril, transfluthrin, transpermethrin, tretamine, triacontanol, triadimefon, triadimenol, triafamone, tri-allate, triamiphos, triapenthenol, triarathene, triarimol, triasulfuron, triazamate, triazbutil, triaziflam, triazophos, triazoxide, tribenuron, tribenuron-methyl, tribufos, tributyltin oxide, tricamba, trichlamide, trichlorfon, trichlormetaphos-3, trichloronat, triclopyr, triclopyr-butotyl, triclopyr-ethyl, triclopyr-triethylammonium, tricyclazole, tridemorph, tridiphane, trietazine, trifenmorph, trifenofos, trifloxystrobin, trifloxysulfuron, trifloxysulfuron-sodium, triflumizole, triflumuron, trifluralin, triflusulfuron, triflusulfuron-methyl, trifop, trifop-methyl, trifopsime, triforine, trihydroxytriazine, trimedlure, trimethacarb, trimeturon, trinexapac, trinexapac-ethyl, triprene, tripropindan, triptolide, tritac, triticonazole, tritosulfuron, trunc-call, uniconazole, uniconazole-P, urbacide, uredepa, valerate, validamycin, valifenalate, valone, vamidothion, vangard, vaniliprole, vernolate, vinclozolin, warfarin, warfarin-potassium, warfarin-sodium, xiaochongliulin, xinjunan, xiwojunan, XMC, xylachlor, xylenols, xylylcarb, yishijing, zarilamid, zeatin, zengxiaoan, zeta-cypermethrin, zinc naphthenate, zinc phosphide, zinc thiazole, zineb, ziram, zolaprofos, zoxamide, zuomihuanglong, α-chlorohydrin, α-ecdysone, α-multistriatin, and α-naphthaleneacetic acid.

In another aspect of the present disclosure, the amount of herbicides present in herbicide compositions may range from about 0.1% to about 50%, from about 0.1% to about 45%, from about 0.1% to about 40%, from about 0.1% to about 35%, from about 0.1% to about 30%, from about 0.1% to about 25%, from about 0.1% to about 24%, from about 0.1% to about 23%, from about 0.1% to about 22%, from about 0.1% to about 21%, from about 0.1% to about 20%, from about 0.1% to about 19%, from about 0.1% to about 18%, from about 0.1% to about 17%, from about 0.1% to about 16%, from about 0.1% to about 15%, from about 0.1% to about 14%, from about 0.1% to about 13%, from about 0.1% to about 12%, from about 0.1% to about 11%, from about 0.1% to about 10%, from about 0.1% to about 9.5%, from about 0.1% to about 9%, from about 0.1% to about 8.5%, from about 0.1% to about 8%, from about 0.1% to about 7.5%, from about 0.1% to about 7%, from about 0.1% to about 6.5%, from about 0.1% to about 6%, from about 0.1% to about 5.5%, from about 0.1% to about 5%, from about 0.1% to about 4.5%, from about 0.1% to about 4%, from about 0.1% to about 3.5%, from about 0.1% to about 3%, from about 0.1% to about 2.5%, from about 0.1% to about 2%, from about 0.1% to about 1.5%, from about 0.1% to about 1%, and from about 0.1% to about 0.5%.

The compound, indaziflam, used in the present disclosure is described in, for example, U.S. Pat. No. 8,114,991, which is hereby incorporated by reference in its entirety. The compound taught by U.S. Pat. No. 8,114,991 is described therein as having herbicidal properties. See U.S. Pat. No. 8,114,991 at, for example, column 62, line 22 to column 72, line 43.

Indaziflam's International Union of Pure and Applied Chemistry (IUPAC) name is N2-[(1R,2S)-2,3-dihydro-2,6-dimethyl-1H-inden-1-yl]-6-[(1RS)-1-fluoroethyl]-1,3,5-triazine-2,4-diamine. Indaziflam is written chemically as C16H20FN5.

Indaziflam is an alkylazine compound characterized as a cellulose biosynthesis inhibitor (CBI), belonging to Weed Science Society of America (“WSSA”) Mode of Action group 29. Cellulose biosynthesis inhibitor herbicides affect synthesis of the cellulose needed for cell walls in susceptible plants, thereby inhibiting cell division. These herbicides are absorbed through susceptible plants' roots and shoot tissues and inhibit root and shoot growth. Additional cellulose biosynthesis inhibitors include herbicides belonging to benzamide (WSSA group 21), nitrile (WSSA group 20), and triazolocarboxamides (WSSA group 28) classes of chemicals. For example, cellulose biosynthesis inhibitors of the benzamide family include isoxaben. Cellulose biosynthesis inhibitors of the nitrile family include dichlobenil and chlorthiamid. Cellulose biosynthesis inhibitors of the triazolocarboxamide family include flupoxam.

Commercially available herbicides incorporating indaziflam as their active ingredient include, for example, Alion®, Esplanade® EZ, Esplanade® 200 SC, Specticle® G, Specticle® FLO, Specticle® Total, Specticle® 20 WSP, Marengo®, and DuraZone®.

Indaziflam is useful as a selective, pre-emergence herbicide for annual grasses and broadleaf weeds. Indaziflam has been approved for use on residential and commercial property, such as golf courses, lawns, walkways, cemeteries, evergreen nurseries, and landscaping projects.

Herbicidal compositions containing indaziflam may be used to control pests, such as annual grasses and broadleaf weeds. Indaziflam works well against, for example, crabgrass, goosegrass, kyllinga, bluegrass, doveweed, swinecress, bittercress, and henbit.

The composition containing a cellulose biosynthesis inhibitor, e.g., indaziflam, can be formulated in any desired manner and include any desired excipients. The compositions can be formulated as a foliar composition, a foliar spray, solutions, emulsions, suspension, coating formulation, encapsulated formulation, solid, liquid, fertilizer, paste, granule, powder, suspension, or suspension concentrate. The composition may be employed alone or in solid, dispersant, or liquid formulation. In yet another aspect, a composition described herein is formulated as a tank-mix product.

Compositions described herein can be applied to a soil, plant, crop, seed, leaf, or plant part thereof in a single application step. In another aspect, compositions described herein may be applied to a plant, crop, seed, leaf, or plant part thereof in multiple application steps, for example, two, three, four, five or more application steps. In another aspect, the second, third, fourth, or fifth or more application steps may be with the same or different compositions. The methods described herein also provide for an aspect where multiple application steps are excluded.

Compositions described herein can be applied to a soil, plant, crop, seed, or plant part thereof to be controlled, for example to control wildfires, one or more times during a growing season. In another aspect, compounds or compositions described herein may be applied to a plant, crop, seed, or plant part thereof in one, two, three, four, or five or more times during a growing season. In another aspect, compounds or compositions described herein may be applied to a plant, crop, seed, or plant part thereof only one time, no more than two times, or no more than three times during a growing season. In yet another aspect, compounds or compositions may be applied in a single step to a seed.

Compositions described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

In another aspect, the disclosure provides for pre-plant, pre-emergent, post-emergent, application steps or combinations thereof. In another aspect, compounds or compositions described herein may be first applied in a pre-plant step and followed by one or more pre-emergent or post-emergent steps. In yet another aspect, the disclosure provides for only a pre-plant step.

### EXAMPLES

All data points were rounded to the nearest whole number where possible except for contents that are below 1%. Datapoints therefore can be expressed as “about” or “approximately”.

Greenhouse Bioassay Results

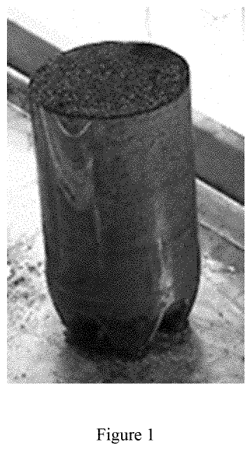

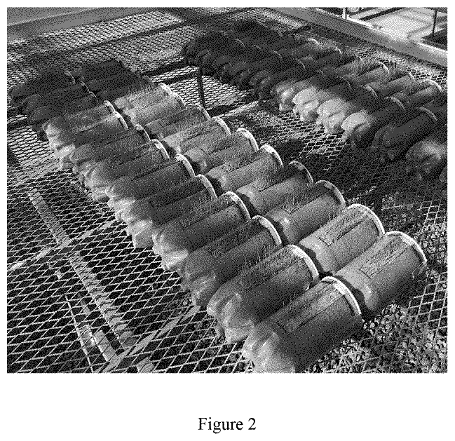

The downward movement of indaziflam through a high sand, low organic matter soil was quantified in greenhouse column studies. Experimental Formulations were compared to a Reference/Standard Formulation (Specticle® FLO) and an Untreated Check (UTC). Perennial ryegrass (Lolium perenne) was used as the bioindicator, due to its high susceptibility to the herbicide. See FIGS. 1 and 2.

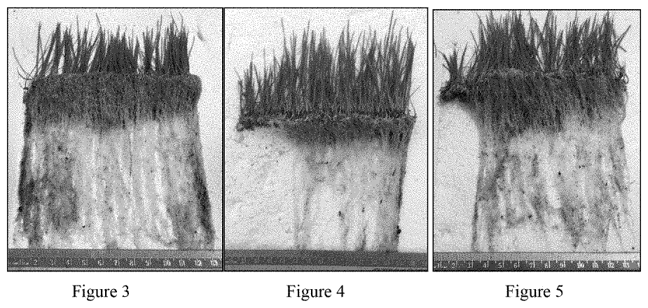

At the end of the experiment, the columns were deconstructed and the perennial ryegrass harvested. Downward migration of indaziflam—from soil surface down into and through the soil profile—was evidenced as no-to-few perennial ryegrass roots in areas where indaziflam was present. The downward distance of indaziflam movement (area with no roots) was measured for every treatment. The perennial ryegrass roots and shoots were physically separated and oven dried. Indaziflam downward migration (distance), Dry root weights and Dry shoot weights were recorded and treatment means calculated. Means were statistically separated via Analysis of Variance (ANOVA) at P=0.05, LSD. See FIGS. 3 to 5.

Results

Tables 1-2. Experimental Formulations effectively reduced indaziflam downward movement through a high sand, low organic matter soil in greenhouse column study. The Dry Root Weights of all Experimental Formulations equaled that of the Untreated Check and were greater than that of the Reference Treatment, Specticle FLO. (Greater [heavier] Dry Root Weights result when more roots are present in the soil profile.)

TABLE 1
Trial HE17USAS1RETQ1

| | Perennial | |
|---|---|---|
| | ryegrass Dry | |
| Treatment | Root Weights (g) | ANOVA |
| UTC | 0.643 | abc |
| Specticle FLO | 0.3853 | e |
| KP003P084-5 | 0.764 | a |
| KP003P085-7 | 0.6643 | ab |
| KO003P085-8 | 0.5302 | bcd |
| KP003P085-9 | 0.7319 | a |

TABLE 2
Trial HE18USASPMETQ2

| | Perennial | |
|---|---|---|
| | ryegrass Dry | |
| Treatment | Root Weights (g) | ANOVA |
| UNTREATED | 0.4366 | ab |
| SPECTICLE FLO | 0.2431 | c |
| KP002/P015_2 | 0.5179 | ab |
| KP003P085-9 | 0.5014 | ab |
| KP003P084-5 | 0.4808 | ab |
| KP003P085-7 | 0.4737 | ab |

TABLE 3
Compositions of Experimental
Formulations Supporting Soil Column Bioassay Studies

| | |
|---|---|
| KP002P015-2 | Indaziflam, preferably 5% |
| | 40-50% solvent,, preferably 45% |
| | 1-4% additives including long chain alcohol, |
| | preferably 3% |
| | 3-7% emulsifier/star polymer, preferably 4% |
| | 3-7% emulsifier, block copolymer, preferably 4% |
| | Antimicrobial Agent, preferably 0.1% |
| | Antifoam Agent, preferably 0.1% |
| | Water preferably 39% |
| KP003P084-5 | Indaziflam, preferably 4% |
| | 40-50% solvent, preferably 46% |
| | 2-4% emulsifier, star polymer, preferably 2% |
| | 2-4% emulsifier, block copolymer, preferably 2% |
| | 4-6% additives including oligosaccharide, preferably |
| | 4% |
| | Antimicrobial Agent, preferably 0.1% |
| | Antifoam Agent, preferably 0.1% |
| | Water, preferably 42% |
| KP003P085-7 | Indaziflam, preferably 4% |
| | 40-50% solvent, preferably 46% |
| | 2-4% emulsifier, star polymer, preferably 2% |
| | 2-4% emulsifier, block copolymer, preferably 2% |
| | 4-15% additives including acrylic comb polymer, |
| | preferably 13% |
| | Antimicrobial Agent, preferably 0.1% |
| | Antifoam Agent, preferably 0.1% |
| | Water, preferably 32.5% |
| KP003P085-8 | Indaziflam, preferably 4% |
| | 40-50% solvent, preferably 46% |
| | 2-4% emulsifier, star polymer, preferably 2% |
| | 4-6% emulsifier, block copolymer, preferably 4% |
| | 4-8% additives including hydroxypropyl methyl |
| | cellulose, preferably 4% |
| | Antimicrobial Agent, preferably 0.1% |
| | Antifoam Agent, preferably 0.1% |
| | Water, 40% |
| KP003P085-9 | Indaziflam, preferably 4% |
| | 40-50% solvent, preferably 46% |
| | 4-7% additives including a long chain alcohol, |
| | preferably 4% |
| | 2.5-5% emulsifier, star polymer, preferably 3% |
| | 3.5-7% emulsifier, block copolymer, preferably 4% |
| | 4-6% additives including hdroxypropyl methyl |
| | cellulose), preferably 4% |
| | Antimicrobial Agent, preferably 0.1 |
| | Antifoam Agent, preferably 0.1% |
| | Water, preferably 35% |

*All formulations in Table 3 included 2-8% indaziflam

Field Trial Results

The objective of Trial HE17USASP5EWL1 was to compare ‘Celebration’ bermudagrass tolerance of the Experimental Formulations in the field to that of the Standard, Specticle FLO, and an Untreated Check. The trial was initiated Aug. 4, 2017 on the driving range at Fort Lauderdale Country Club, Ft. Lauderdale, Fla. The site consisted of high sand/low organic matter soil. One-half inch irrigation was applied daily after the treatments were applied for 7 days to exacerbate indaziflam movement through the soil profile. At 18 DAT, Hurricane Irma produced an additional ˜9″ rainfall. The site experience droughty conditions at 193-207 DAT. The trial was terminated at 207 DAT.

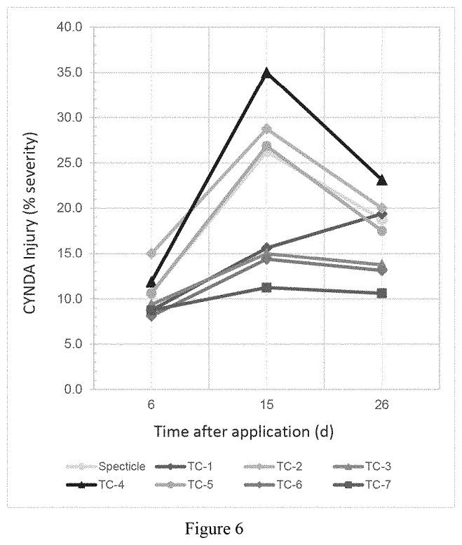

INJURY—See FIG. 6 and Table 4. Foliar turf injury was visually evident at 6-26 DAT. At 6 DAT, injury was attributable to mower scalping. At 15 DAT, injury was attributable to treatment effects. ‘Unacceptable’ injury was defined as injury exceeding 20%. TC-1, TC-3, TC-6 and TC-7 always remained within the ‘Acceptable’ region.

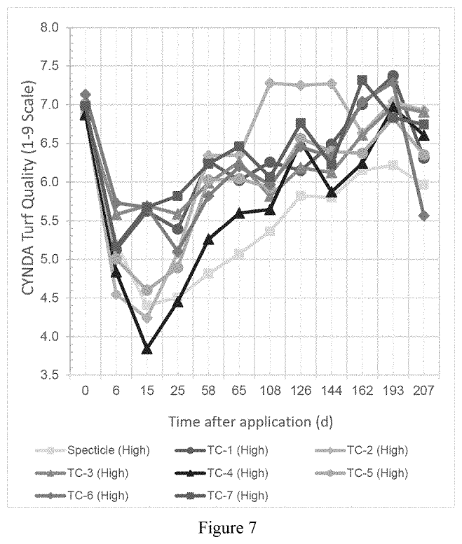

TURF QUALITY—See FIG. 7 and Table 5. Turf Quality (TQ) ratings were taken at 0-207 DAT. A rating of ‘6’ was defined as Minimally Acceptable TQ and a rating of ‘9’ was defined as Outstanding/Ideal Turf. Specticle FLO (the Reference or Standard Treatment) did not regain acceptable TQ until 162 DAT. TC-7 generated numerically the highest turf quality over the initial 162 day period but was statistically equivalent to TC-1, TC-3, and TC-6.

It was noted that drought stress had been experienced as the dry-season intensifies and as a result, turf quality declined for TC-6, particularly in bermudagrass. Turf quality has remained relatively constant for TC.

A second trial, HE17USASP4EWL1, was conducted on St. Augustine grass with comparable results.

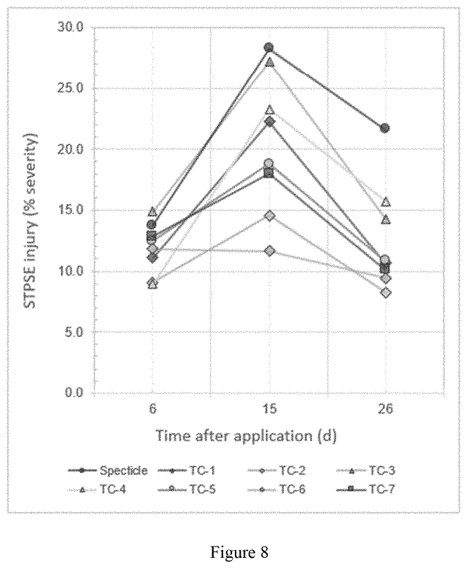

INJURY—See FIG. 8 and Table 6. Foliar turf injury was visually evident at 6-26 DAT. At 6 DAT, injury was attributable to mower scalping. At 15 DAT, injury was attributable to treatment effects. ‘Unacceptable’ injury was defined as injury exceeding 20%. TC-1, TC-5, TC-6 and TC-7 always remained within the ‘Acceptable’ region.

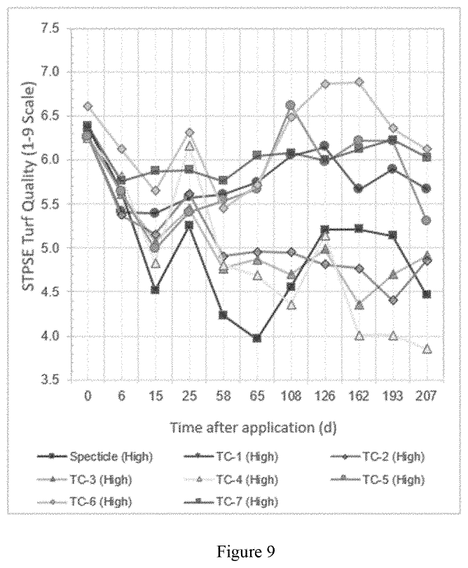

TURF QUALITY—See FIG. 9 and Table 7. Turf Quality (TQ) ratings were taken at 0-207 DAT. A rating of ‘6’ was defined as Minimally Acceptable TQ and a rating of ‘9’ was defined as Outstanding/Ideal Turf. When pooled, TC-1, TC-5, TC-6, and TC-7 generated higher turf quality than Specticle. Of these test compounds, TC-6 separated from the others when comparing pooled means of TC-1, 5, 7. In direct comparisons, TC-6 was the only compound to produce higher turf quality than TC-1 and TC-5. Although TC-6 produced similar turf quality as TC-7, the latter did not differ statistically from TC-1 or TC-5. Specticle FLO (the Reference or Standard Treatment) achieved Acceptable TQ during the interval 108-126 DAT.

In St. Augustinegrass, high ranking test compounds in bermudagrass (e.g. TC-1, 6, and 7) also performed well in terms of reduced turf quality declines compared to Specticle.

However, in this species, greater separation was observed between test compounds 1, 6, and 7 and TC-6 statistically produced higher turf quality than TC-1 over the experimental period.

Although, TC-6 and TC-7 generated similar turf quality statistically, TC-7 was similar to TC-1 and therefore one could extrapolate better responses from TC-6 as a result.

In conclusion, TC-1, 6, and 7 all produced better turf quality than Specticle across both turfgrass species.

These data clearly demonstrate the reduction of indaziflam downward flow through the soil profile and consequent improvement in turf tolerance via Formulation.

TABLE 8
Compositions of Experimental Formulations Supporting Field Trials

| | |
|---|---|
| TC-1 | Indaziflam, preferably 4% |
| | 0.5-2% polymer, preferably 1% |
| | 90%-98% solvent, preferably 95% |
| TC-2 | Indaziflam, preferably 5%, |
| | 4-6% emulsifier, block copolymer, preferably 5% |
| | 4-6% anionic emulsifier, preferably 5% |
| | 80-90% solvent, preferably 85% |
| TC-3 | Indaziflam, preferably 4% |
| | 40-50% solvent, preferably 45% |
| | 2-5% additives including long chain alcohol, preferably 3% |
| | 1-2% nonionic emulsifier, preferably 1% |
| | 0.5%-1.5 nonionic emulsifier, preferably 1% |
| | 0.7%-1.8% nonionic emulsifier, preferably 1% |
| | Antimicrobial Agent, preferably 0.1% |
| | Antifoam Agent, preferably 0.1% |
| | Water, 47% |
| TC-4 | Indaziflam, preferably 10% |
| | 12%-20% additives including one or more dispersing agent, |
| | preferably 15% |
| | 1-3% additives including polyvinylpyrrolidone polymer, |
| | preferably 2% |
| | 40-50% organic compound, preferably 43% |
| | 25-35% carrier material, preferably 30% |
| TC-5 | Indaziflam, preferably 5% |
| | 0.5-1.5% polymer, preferably 1% |
| | 4-6% nonionic emulsifier, block copolymer, preferably 5% |
| | 4-6% anionic emulsifier, preferably 5% |
| | 80-90% solvent, preferably 84% |
| TC-6 | Indaziflam, preferably 5% |
| | 40-50% solvent, preferably 45% |
| | 1-3% nonionic emulsifier, star polymer, preferably 2% |
| | 1-3% nonionic polymeric emulsifier, block copolymer, |
| | preferably 2% |
| | Antimicrobial Agent, preferably 0.1% |
| | Antifoam Agent, preferably 0.1% |
| | Water, preferably 46% |
| TC-7 | Indaziflam, preferably 5% |
| | 40-50% solvent, preferably 45% |
| | 3% additives including long chain alcohol, preferably 3% |
| | 2-6% nonionic emulsifier, star polymer, preferably 4% |
| | 2-6% nonionic polymeric emulsifier, block copolymer, |
| | preferably 4% |
| | Antimicrobial Agent, preferably 0.1% |
| | Antifoam Agent, preferably 0.1% |
| | Water, preferably 39% |

*All formulations include from 4-12% indaziflam

All formulations provide ranges for the components as well as specific quantities utilized.

As shown by the instant examples, when not using an emulsified concentrate or EW formulation, the turf took approx. 6 months to reach acceptable quality in terms of greenness and density, whereas by using EW, the turf returned to acceptable quality in around 1 month. In other words, the turf recovered 6 times more quickly than when an emulsiable concentrate or oil in water emulsion was NOT used. This is very significant in terms of performance. The reason why the turf recovered so much more quickly using formulations according to the present invention is because the downward migration of the active was very much hindered and permitted the turf and other vegetation to return to acceptable quality much more readily. This also provides a significant advantage because for many indications, having green and dense turf and vegetation is highly desirable and being able to have a product and associated method that allows quick recovery is something that has not been seen previously in this regard, particularly when the active ingredient is a compound such as Indaziflam. However, it is envisioned that the same formulations could also be utilized with other active ingredients including those with a similar profile to indaziflam and/or any pesticide with a similar result in terms of increased performance due to decreased downward migration of the active ingredient.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

TABLE 4
Treatment Contrasts Corresponding to FIG. 6.

| Contrast label | F Value | Pr > F |
|---|---|---|
| Specticle vs. Others | 0.87 | 0.3546 |
| Specticle vs. TC-2,4,5 | 0.69 | 0.4085 |
| Specticle vs. TC-1,3,6,7 | 5.01 | 0.0290 |
| TC-6 vs. TC-1,3,7 | 0.05 | 0.8263 |
| TC-7 vs. TC-1,3,6 | 1.01 | 0.3192 |
| TC-6 vs. Specticle | 3.53 | 0.0657 |
| TC-7 vs. Specticle | 5.52 | 0.0226 |
| TC-4 vs. TC-2,5 | 1.41 | 0.2397 |
| TC-4 vs. Specticle | 1.83 | 0.1825 |
| TC-1 vs. TC-2 | 3.85 | 0.0533 |
| TC-1 vs. TC-3 | 0.28 | 0.5993 |
| TC-1 vs. TC-6 | 0.58 | 0.4485 |
| TC-1 vs. TC-7 | 1.52 | 0.2229 |
| TC-2 vs. TC-3 | 6.32 | 0.0140 |
| TC-2 vs. TC-6 | 6.99 | 0.0108 |
| TC-2 vs. TC-7 | 9.69 | 0.0030 |
| TC-3 vs. TC-6 | 0.06 | 0.8152 |
| TC-3 vs. TC-7 | 0.50 | 0.4840 |
| TC-6 vs. TC-7 | 0.24 | 0.6251 |

TABLE 5
Treatment Contrasts Corresponding to FIG. 7.

| Contrast label | F Value | Pr > F |
|---|---|---|
| Specticle (High) vs. Others (High) | 26.39 | <.0001 |
| Specticle (High) vs. TC-2,4,5 (High) | 14.40 | 0.0002 |
| Specticle (High) vs. TC-1,3,6,7 (High) | 31.71 | <.0001 |
| TC-6 (High) vs. TC-1,3,7 (High) | 0.38 | 0.5377 |
| TC-7 (High) vs. TC-1,3,6 (High) | 1.11 | 0.2922 |
| TC-6 (High) vs. Specticle (High) | 16.86 | <.0001 |
| TC-7 (High) vs. Specticle (High) | 25.49 | <.0001 |
| TC-4 (High) vs. TC-2,5 (High) | 9.62 | 0.0020 |
| TC-4 (High) vs. Specticle (High) | 1.69 | 0.1939 |
| TC-1 (High) vs. TC-2 (High) | 0.19 | 0.6636 |
| TC-1 (High) vs. TC-3 (High) | 0.04 | 0.8385 |
| TC-1 (High) vs. TC-6 (High) | 0.12 | 0.7245 |
| TC-1 (High) vs. TC-7 (High) | 0.47 | 0.4955 |
| TC-2 (High) vs. TC-3 (High) | 0.41 | 0.5246 |
| TC-2 (High) vs. TC-6 (High) | 0.60 | 0.4391 |
| TC-2 (High) vs. TC-7 (High) | 0.05 | 0.8228 |
| TC-3 (High) vs. TC-6 (High) | 0.02 | 0.8783 |
| TC-3 (High) vs. TC-7 (High) | 0.74 | 0.3912 |
| TC-6 (High) vs. TC-7 (High) | 1.02 | 0.3133 |

TABLE 6
Treatment Contrasts Corresponding to FIG. 8.

| Contrast label | F Value | Pr > F |
|---|---|---|
| Specticle vs. Others | 12.51 | 0.0006 |
| Specticle vs. TC-1,5,6,7 | 12.95 | 0.0005 |
| TC-1 vs. TC-5,6,7 | 0.50 | 0.4803 |
| TC-5 vs. TC-1,6,7 | 0.27 | 0.6067 |
| TC-6 vs. TC-1,5,7 | 2.51 | 0.1163 |
| TC-7 vs. TC-1,5,6 | 0.10 | 0.7567 |
| TC-1 vs. Specticle | 5.86 | 0.0172 |
| TC-5 vs. Specticle | 5.03 | 0.0269 |
| TC-6 vs. Specticle | 14.55 | 0.0002 |
| TC-7 vs. Specticle | 6.80 | 0.0104 |
| TC-1 vs. TC-5 | 0.00 | 0.9453 |
| TC-1 vs. TC-6 | 2.04 | 0.1562 |
| TC-1 vs. TC-7 | 0.06 | 0.8071 |
| TC-2 vs. TC-6 | 0.11 | 0.7381 |
| TC-3 vs. TC-6 | 7.50 | 0.0073 |
| TC-4 vs. TC-6 | 3.55 | 0.0621 |
| TC-5 vs. TC-6 | 1.54 | 0.2169 |
| TC-6 vs. TC-7 | 1.36 | 0.2468 |
| TC-5 vs. TC-7 | 0.02 | 0.8810 |

TABLE 7
Treatment Contrasts Corresponding to FIG. 9.

| Contrast label | F Value | Pr > F |
|---|---|---|
| Specticle (High) vs. Others (High) | 17.5 | <.0001 |
| Specticle (High) vs. TC-1,5,6,7 (High) | 43.02 | <.0001 |
| TC-1 (High) vs. TC-5,6,7 (High) | 2.76 | 0.0975 |
| TC-5 (High) vs. TC-1,6,7 (High) | 1.75 | 0.1863 |
| TC-6 (High) vs. TC-1,5,7 (High) | 5.86 | 0.0159 |
| TC-7 (High) vs. TC-1,5,6 (High) | 0.29 | 0.5876 |
| TC-1 (High) vs. Specticle (High) | 18.05 | <.0001 |
| TC-5 (High) vs. Specticle (High) | 19.42 | <.0001 |
| TC-6 (High) vs. Specticle (High) | 45.52 | <.0001 |
| TC-7 (High) vs. Specticle (High) | 30.45 | <.0001 |
| TC-1 (High) vs. TC-5 (High) | 0.04 | 0.8388 |
| TC-1 (High) vs. TC-6 (High) | 6.06 | 0.0142 |
| TC-1 (High) vs. TC-7 (High) | 1.93 | 0.1661 |
| TC-2 (High) vs. TC-6 (High) | 35.33 | <.0001 |
| TC-3 (High) vs. TC-6 (High) | 39.77 | <.0001 |
| TC-4 (High) vs. TC-6 (High) | 48.49 | <.0001 |
| TC-5 (High) vs. TC-6 (High) | 5.49 | 0.0196 |
| TC-6 (High) vs. TC-7 (High) | 1.34 | 0.2478 |
| TC-5 (High) vs. TC-7 (High) | 1.28 | 0.2584 |

1. A method of reducing downward migration of a pesticide in soil or on vegetation including turf or an area in proximity thereto, comprising
Applying a composition comprising a pesticide that is solubilized in a predominantly water-immiscible solvent to form an oil in water emulsion or an emulsifiable concentrate wherein said pesticide exhibits superior performance due to decreased downward migration in soil as compared with said pesticide which is not in an oil in water emulsion form or an emulsifiable concentrate

2. The method of claim 1, wherein the pesticide comprises a herbicide.

3. The method of claim 1, wherein the pesticide comprises a herbicide that is completely dissolved in said oil in water emulsion or said emulsifiable concentrate.

4. The method of claim 1,wherein said composition comprises said pesticide, a solvent, an emulsifier(s), optionally one or more additives, optionally one or more antifoam agents, optionally one or more antimicrobial agents and balance water.

5. The method of claim 1,wherein said composition comprises said pesticide, a solvent, an emulsifier(s), optionally one or more additives, optionally one or more antifoam agents, and optionally one or more antimicrobial agents.

6. The method of claim 4, wherein said solvent comprises a long chain di-substituted amide.

7. The method of claim 1 wherein the pesticide is at least one selected from the group consisting of (3-ethoxypropyl)mercury bromide, 1,2-dichloropropane, 1,3-dichloropropene, 1-methylcyclopropene, 1-naphthol, 2-(octylthio)ethanol, 2,3,5-tri-iodobenzoic acid, 2,3,6-TBA, 2,3,6-TBA-dimethylammonium, 2,3,6-TBA-lithium, 2,3,6-TBA-potassium, 2,3,6-TBA-sodium, 2,4,5-T, 2,4,5-T-2-butoxypropyl, 2,4,5-T-2-ethylhexyl, 2,4,5-T-3-butoxypropyl, 2,4,5-TB, 2,4,5-T-butometyl, 2,4,5-T-butotyl, 2,4,5-T-butyl, 2,4,5-T-isobutyl, 2,4,5-T-isoctyl, 2,4,5-T-isopropyl, 2,4,5-T-methyl, 2,4,5-T-pentyl, 2,4,5-T-sodium, 2,4,5-T-triethylammonium, 2,4,5-T-trolamine, 2,4-D, 2,4-D-2-butoxypropyl, 2,4-D-2-ethylhexyl, 2,4-D-3-butoxypropyl, 2,4-D-ammonium, 2,4-DB, 2,4-DB-butyl, 2,4-DB-dimethylammonium, 2,4-DB-isoctyl, 2,4-DB-potassium, 2,4-DB-sodium, 2,4-D-butotyl, 2,4-D-butyl, 2,4-D-diethylammonium, 2,4-D-dimethylammonium, 2,4-D-diolamine, 2,4-D-dodecylammonium, 2,4-DEB, 2,4-DEP, 2,4-D-ethyl, 2,4-D-heptylammonium, 2,4-D-isobutyl, 2,4-D-isoctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-potassium, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 2iP, 2-methoxyethylmercury chloride, 2-phenylphenol, 3,4-DA, 3,4-DB, 3,4-DP, 4-aminopyridine, 4-CPA, 4-CPA-potassium, 4-CPA-sodium, 4-CPB, 4-CPP, 4-hydroxyphenethyl alcohol, 8-hydroxyquinoline sulfate, 8-phenylmercurioxyquinoline, abamectin, abscisic acid, ACC, acephate, acequinocyl, acetamiprid, acethion, acetochlor, acetophos, acetoprole, acibenzolar, acibenzolar-S-methyl, acifluorfen, acifluorfen-methyl, acifluorfen-sodium, aclonifen, acrep, acrinathrin, acrolein, acrylonitrile, acypetacs, acypetacs-copper, acypetacs-zinc, alachlor, alanycarb, albendazole, aldicarb, aldimorph, aldoxycarb, aldrin, allethrin, allicin, allidochlor, allosamidin, alloxydim, alloxydim-sodium, allyl alcohol, allyxycarb, alorac, alpha-cypermethrin, alpha-endosulfan, ametoctradin, ametridione, ametryn, amibuzin, amicarbazone, amicarthiazol, amidithion, amidoflumet, amidosulfuron, aminocarb, aminocyclopyrachlor, aminocyclopyrachlor-methyl, aminocyclopyrachlor-potassium, aminopyralid, aminopyralid-potassium, aminopyralid-tris(2-hydroxypropyl)ammonium, amiprofos-methyl, amiprophos, amisulbrom, amiton, amiton oxalate, amitraz, amitrole, ammonium sulfamate, ammonium α-naphthaleneacetate, amobam, ampropylfos, anabasine, ancymidol, anilazine, anilofos, anisuron, anthraquinone, antu, apholate, aramite, arsenous oxide, asomate, aspirin, asulam, asulam-potassium, asulam-sodium, athidathion, atraton, atrazine, aureofungin, aviglycine, aviglycine hydrochloride, azaconazole, azadirachtin, azafenidin, azamethiphos, azimsulfuron, azinphos-ethyl, azinphos-methyl, aziprotryne, azithiram, azobenzene, azocyclotin, azothoate, azoxystrobin, bachmedesh, barban, barium hexafluorosilicate, barium polysulfide, barthrin, BCPC, beflubutamid, benalaxyl, benalaxyl-M, benazolin, benazolin-dimethylammonium, benazolin-ethyl, benazolin-potassium, bencarbazone, benclothiaz, bendiocarb, benfluralin, benfuracarb, benfuresate, benodanil, benomyl, benoxacor, benoxafos, benquinox, bensulfuron, bensulfuron-methyl, bensulide, bensultap, bentaluron, bentazone, bentazone-sodium, benthiavalicarb, benthiavalicarb-isopropyl, benthiazole, bentranil, benzadox, benzadox-ammonium, benzalkonium chloride, benzamacril, benzamacril-isobutyl, benzamorf, benzfendizone, benzipram, benzobicyclon, benzofenap, benzofluor, benzohydroxamic acid, benzoximate, benzoylprop, benzoylprop-ethyl, benzthiazuron, benzyl benzoate, benzyladenine, berberine, berberine chloride, beta-cyfluthrin, beta-cypermethrin, bethoxazin, bicyclopyrone, bifenazate, bifenox, bifenthrin, bifujunzhi, bilanafos, bilanafos-sodium, binapacryl, bingqingxiao, bioallethrin, bioethanomethrin, biopermethrin, bioresmethrin, biphenyl, bisazir, bismerthiazol, bispyribac, bispyribac-sodium, bistrifluron, bitertanol, bithionol, bixafen, blasticidin-S, borax, Bordeaux mixture, boric acid, boscalid, brassinolide, brassinolide-ethyl, brevicomin, brodifacoum, brofenvalerate, brofluthrinate, bromacil, bromacil-lithium, bromacil-sodium, bromadiolone, bromethalin, bromethrin, bromfenvinfos, bromoacetamide, bromobonil, bromobutide, bromocyclen, bromo-DDT, bromofenoxim, bromophos, bromophos-ethyl, bromopropylate, bromothalonil, bromoxynil, bromoxynil butyrate, bromoxynil heptanoate, bromoxynil octanoate, bromoxynil-potassium, brompyrazon, bromuconazole, bronopol, bucarpolate, bufencarb, buminafos, bupirimate, buprofezin, Burgundy mixture, busulfan, butacarb, butachlor, butafenacil, butamifos, butathiofos, butenachlor, butethrin, buthidazole, buthiobate, buthiuron, butocarboxim, butonate, butopyronoxyl, butoxycarboxim, butralin, butroxydim, buturon, butylamine, butylate, cacodylic acid, cadusafos, cafenstrole, calcium arsenate, calcium chlorate, calcium cyanamide, calcium polysulfide, calvinphos, cambendichlor, camphechlor, camphor, captafol, captan, carbamorph, carbanolate, carbaryl, carbasulam, carbendazim, carbendazim benzenesulfonate, carbendazim sulfite, carbetamide, carbofuran, carbon disulfide, carbon tetrachloride, carbophenothion, carbosulfan, carboxazole, carboxide, carboxin, carfentrazone, carfentrazone-ethyl, carpropamid, cartap, cartap hydrochloride, carvacrol, carvone, CDEA, cellocidin, CEPC, ceralure, Cheshunt mixture, chinomethionat, chitosan, chlobenthiazone, chlomethoxyfen, chloralose, chloramben, chloramben-ammonium, chloramben-diolamine, chloramben-methyl, chloramben-methylammonium, chloramben-sodium, chloramine phosphorus, chloramphenicol, chloraniformethan, chloranil, chloranocryl, chlorantraniliprole, chlorazifop, chlorazifop-propargyl, chlorazine, chlorbenside, chlorbenzuron, chlorbicyclen, chlorbromuron, chlorbufam, chlordane, chlordecone, chlordimeform, chlordimeform hydrochloride, chlorempenthrin, chlorethoxyfos, chloreturon, chlorfenac, chlorfenac-ammonium, chlorfenac-sodium, chlorfenapyr, chlorfenazole, chlorfenethol, chlorfenprop, chlorfenson, chlorfensulphide, chlorfenvinphos, chlorfluazuron, chlorflurazole, chlorfluren, chlorfluren-methyl, chlorflurenol, chlorflurenol-methyl, chloridazon, chlorimuron, chlorimuron-ethyl, chlormephos, chlormequat, chlormequat chloride, chlornidine, chlornitrofen, chlorobenzilate, chlorodinitronaphthalenes, chloroform, chloromebuform, chloromethiuron, chloroneb, chlorophacinone, chlorophacinone-sodium, chloropicrin, chloropon, chloropropylate, chlorothalonil, chlorotoluron, chloroxuron, chloroxynil, chlorphonium, chlorphonium chloride, chlorphoxim, chlorprazophos, chlorprocarb, chlorpropham, chlorpyrifos, chlorpyrifos-methyl, chlorquinox, chlorsulfuron, chlorthal, chlorthal-dimethyl, chlorthal-monomethyl, chlorthiamid, chlorthiophos, chlozolinate, choline chloride, chromafenozide, cinerin I, cinerin II, cinerins, cinidon-ethyl, cinmethylin, cinosulfuron, ciobutide, cisanilide, cismethrin, clethodim, climbazole, cliodinate, clodinafop, clodinafop-propargyl, cloethocarb, clofencet, clofencet-potassium, clofentezine, clofibric acid, clofop, clofop-isobutyl, clomazone, clomeprop, cloprop, cloproxydim, clopyralid, clopyralid-methyl, clopyralid-olamine, clopyralid-potassium, clopyralid-tris(2-hydroxypropyl)ammonium, cloquintocet, cloquintocet-mexyl, cloransulam, cloransulam-methyl, closantel, clothianidin, clotrimazole, cloxyfonac, cloxyfonac-sodium, CMA, codlelure, colophonate, copper acetate, copper acetoarsenite, copper arsenate, copper carbonate, basic, copper hydroxide, copper naphthenate, copper oleate, copper oxychloride, copper silicate, copper sulfate, copper zinc chromate, coumachlor, coumafuryl, coumaphos, coumatetralyl, coumithoate, coumoxystrobin, CPMC, CPMF, CPPC, credazine, cresol, crimidine, crotamiton, crotoxyphos, crufomate, cryolite, cue-lure, cufraneb, cumyluron, cuprobam, cuprous oxide, curcumenol, cyanamide, cyanatryn, cyanazine, cyanofenphos, cyanophos, cyanthoate, cyantraniliprole, cyazofamid, cybutryne, cyclafuramid, cyclanilide, cyclethrin, cycloate, cycloheximide, cycloprate, cycloprothrin, cyclosulfamuron, cycloxydim, cycluron, cyenopyrafen, cyflufenamid, cyflumetofen, cyfluthrin, cyhalofop, cyhalofop-butyl, cyhalothrin, cyhexatin, cymiazole, cymiazole hydrochloride, cymoxanil, cyometrinil, cypendazole, cypermethrin, cyperquat, cyperquat chloride, cyphenothrin, cyprazine, cyprazole, cyproconazole, cyprodinil, cyprofuram, cypromid, cyprosulfamide, cyromazine, cythioate, daimuron, dalapon, dalapon-calcium, dalapon-magnesium, dalapon-sodium, daminozide, dayoutong, dazomet, dazomet-sodium, DBCP, d-camphor, DCIP, DCPTA, DDT, debacarb, decafentin, decarbofuran, dehydroacetic acid, delachlor, deltamethrin, demephion, demephion-O, demephion-S, demeton, demeton-methyl, demeton-O, demeton-O-methyl, demeton-S, demeton-S-methyl, demeton-S-methylsulphon, desmedipham, desmetryn, d-fanshiluquebingjuzhi, diafenthiuron, dialifos, di-allate, diamidafos, diatomaceous earth, diazinon, dibutyl phthalate, dibutyl succinate, dicamba, dicamba-diglycolamine, dicamba-dimethylammonium, dicamba-diolamine, dicamba-isopropylammonium, dicamba-methyl, dicamba-olamine, dicamba-potassium, dicamba-sodium, dicamba-trolamine, dicapthon, dichlobenil, dichlofenthion, dichlofluanid, dichlone, dichloralurea, dichlorbenzuron, dichlorflurenol, dichlorflurenol-methyl, dichlormate, dichlormid, dichlorophen, dichlorprop, dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P-2-ethylhexyl, dichlorprop-P-dimethylammonium, dichlorprop-potassium, dichlorprop-sodium, dichlorvos, dichlozoline, diclobutrazol, diclocymet, diclofop, diclofop-methyl, diclomezine, diclomezine-sodium, dicloran, diclosulam, dicofol, dicoumarol, dicresyl, dicrotophos, dicyclanil, dicyclonon, dieldrin, dienochlor, diethamquat, diethamquat dichloride, diethatyl, diethatyl-ethyl, diethofencarb, dietholate, diethyl pyrocarbonate, diethyltoluamide, difenacoum, difenoconazole, difenopenten, difenopenten-ethyl, difenoxuron, difenzoquat, difenzoquat metilsulfate, difethialone, diflovidazin, diflubenzuron, diflufenican, diflufenzopyr, diflufenzopyr-sodium, diflumetorim, dikegulac, dikegulac-sodium, dilor, dimatif, dimefluthrin, dimefox, dimefuron, dimepiperate, dimetachlone, dimetan, dimethacarb, dimethachlor, dimethametryn, dimethenamid, dimethenamid-P, dimethipin, dimethirimol, dimethoate, dimethomorph, dimethrin, dimethyl carbate, dimethyl phthalate, dimethylvinphos, dimetilan, dimexano, dimidazon, dimoxystrobin, dinex, dinex-diclexine, dingjunezuo, diniconazole, diniconazole-M, dinitramine, dinobuton, dinocap, dinocap-4, dinocap-6, dinocton, dinofenate, dinopenton, dinoprop, dinosam, dinoseb, dinoseb acetate, dinoseb-ammonium, dinoseb-diolamine, dinoseb-sodium, dinoseb-trolamine, dinosulfon, dinotefuran, dinoterb, dinoterb acetate, dinoterbon, diofenolan, dioxabenzofos, dioxacarb, dioxathion, diphacinone, diphacinone-sodium, diphenamid, diphenyl sulfone, diphenylamine, dipropalin, dipropetryn, dipyrithione, diquat, diquat dibromide, disparlure, disul, disulfiram, disulfoton, disul-sodium, ditalimfos, dithianon, dithicrofos, dithioether, dithiopyr, diuron, d-limonene, DMPA, DNOC, DNOC-ammonium, DNOC-potassium, DNOC-sodium, dodemorph, dodemorph acetate, dodemorph benzoate, dodicin, dodicin hydrochloride, dodicin-sodium, dodine, dofenapyn, dominicalure, doramectin, drazoxolon, DSMA, dufulin, EBEP, EBP, ecdysterone, edifenphos, eglinazine, eglinazine-ethyl, emamectin, emamectin benzoate, EMPC, empenthrin, endosulfan, endothal, endothal-diammonium, endothal-dipotassium, endothal-disodium, endothion, endrin, enestroburin, EPN, epocholeone, epofenonane, epoxiconazole, eprinomectin, epronaz, EPTC, erbon, ergocalciferol, erlujixiancaoan, esdépalléthrine, esfenvalerate, esprocarb, etacelasil, etaconazole, etaphos, etem, ethaboxam, ethachlor, ethalfluralin, ethametsulfuron, ethametsulfuron-methyl, ethaprochlor, ethephon, ethidimuron, ethiofencarb, ethiolate, ethion, ethiozin, ethiprole, ethirimol, ethoate-methyl, ethofumesate, ethohexadiol, ethoprophos, ethoxyfen, ethoxyfen-ethyl, ethoxyquin, ethoxysulfuron, ethychlozate, ethyl formate, ethyl α-naphthaleneacetate, ethyl-DDD, ethylene, ethylene dibromide, ethylene dichloride, ethylene oxide, ethylicin, ethylmercury 2,3-dihydroxypropyl mercaptide, ethylmercury acetate, ethylmercury bromide, ethylmercury chloride, ethylmercury phosphate, etinofen, etnipromid, etobenzanid, etofenprox, etoxazole, etridiazole, etrimfos, eugenol, EXD, famoxadone, famphur, fenamidone, fenaminosulf, fenamiphos, fenapanil, fenarimol, fenasulam, fenazaflor, fenazaquin, fenbuconazole, fenbutatin oxide, fenchlorazole, fenchlorazole-ethyl, fenchlorphos, fenclorim, fenethacarb, fenfluthrin, fenfuram, fenhexamid, fenitropan, fenitrothion, fenjuntong, fenobucarb, fenoprop, fenoprop-3-butoxypropyl, fenoprop-butometyl, fenoprop-butotyl, fenoprop-butyl, fenoprop-isoctyl, fenoprop-methyl, fenoprop-potassium, fenothiocarb, fenoxacrim, fenoxanil, fenoxaprop, fenoxaprop-ethyl, fenoxaprop-P, fenoxaprop-P-ethyl, fenoxasulfone, fenoxycarb, fenpiclonil, fenpirithrin, fenpropathrin, fenpropidin, fenpropimorph, fenpyrazamine, fenpyroximate, fenridazon, fenridazon-potassium, fenridazon-propyl, fenson, fensulfothion, fenteracol, fenthiaprop, fenthiaprop-ethyl, fenthion, fenthion-ethyl, fentin, fentin acetate, fentin chloride, fentin hydroxide, fentrazamide, fentrifanil, fenuron, fenuron TCA, fenvalerate, ferbam, ferimzone, ferrous sulfate, fipronil, flamprop, flamprop-isopropyl, flamprop-M, flamprop-methyl, flamprop-M-isopropyl, flamprop-M-methyl, flazasulfuron, flocoumafen, flometoquin, flonicamid, florasulam, florpyrauxifen, fluacrypyrim, fluazifop, fluazifop-butyl, fluazifop-methyl, fluazifop-P, fluazifop-P-butyl, fluazinam, fluazolate, fluazuron, flubendiamide, flubenzimine, flucarbazone, flucarbazone-sodium, flucetosulfuron, fluchloralin, flucofuron, flucycloxuron, flucythrinate, fludioxonil, fluenetil, fluensulfone, flufenacet, flufenerim, flufenican, flufenoxuron, flufenprox, flufenpyr, flufenpyr-ethyl, flufiprole, flumethrin, flumetover, flumetralin, flumetsulam, flumezin, flumiclorac, flumiclorac-pentyl, flumioxazin, flumipropyn, flumorph, fluometuron, fluopicolide, fluopyram, fluorbenside, fluoridamid, fluoroacetamide, fluorodifen, fluoroglycofen, fluoroglycofen-ethyl, fluoroimide, fluoromidine, fluoronitrofen, fluothiuron, fluotrimazole, fluoxastrobin, flupoxam, flupropacil, flupropadine, flupropanate, flupropanate-sodium, flupyradifurone, flupyrsulfuron, flupyrsulfuron-methyl, flupyrsulfuron-methyl-sodium, fluquinconazole, flurazole, flurenol, flurenol-butyl, flurenol-methyl, fluridone, flurochloridone, fluroxypyr, fluroxypyr-butometyl, fluroxypyr-meptyl, flurprimidol, flursulamid, flurtamone, flusilazole, flusulfamide, fluthiacet, fluthiacet-methyl, flutianil, flutolanil, flutriafol, fluvalinate, fluxapyroxad, fluxofenim, folpet, fomesafen, fomesafen-sodium, fonofos, foramsulfuron, forchlorfenuron, formaldehyde, formetanate, formetanate hydrochloride, formothion, formparanate, formparanate hydrochloride, fosamine, fosamine-ammonium, fosetyl, fosetyl-aluminium, fosmethilan, fospirate, fosthiazate, fosthietan, frontalin, fuberidazole, fucaojing, fucaomi, funaihecaoling, fuphenthiourea, furalane, furalaxyl, furamethrin, furametpyr, furathiocarb, furcarbanil, furconazole, furconazole-cis, furethrin, furfural, furilazole, furmecyclox, furophanate, furyloxyfen, gamma-cyhalothrin, gamma-HCH, genit, gibberellic acid, gibberellins, gliftor, glufosinate, glufosinate-ammonium, glufosinate-P, glufosinate-P-ammonium, glufosinate-P-sodium, glyodin, glyoxime, glyphosate, glyphosate-diammonium, glyphosate-dimethylammonium, glyphosate-isopropylammonium, glyphosate-monoammonium, glyphosate-potassium, glyphosate-sesquisodium, glyphosate-trimesium, glyphosine, gossyplure, grandlure, griseofulvin, guazatine, guazatine acetates, halacrinate, halauxifen, halfenprox, halofenozide, halosafen, halosulfuron, halosulfuron-methyl, haloxydine, haloxyfop, haloxyfop-etotyl, haloxyfop-methyl, haloxyfop-P, haloxyfop-P-etotyl, haloxyfop-P-methyl, haloxyfop-sodium, HCH, hemel, hempa, HEOD, heptachlor, heptenophos, heptopargil, heterophos, hexachloroacetone, hexachlorobenzene, hexachlorobutadiene, hexachlorophene, hexaconazole, hexaflumuron, hexaflurate, hexalure, hexamide, hexazinone, hexylthiofos, hexythiazox, HHDN, holosulf, huancaiwo, huangcaoling, huanjunzuo, hydramethylnon, hydrargaphen, hydrated lime, hydrogen cyanide, hydroprene, hymexazol, hyquincarb, IAA, IBA, icaridin, imazalil, imazalil nitrate, imazalil sulfate, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazaquin-methyl, imazaquin-sodium, imazethapyr, imazethapyr-ammonium, imazosulfuron, imibenconazole, imicyafos, imidacloprid, imidaclothiz, iminoctadine, iminoctadine triacetate, iminoctadine trialbesilate, imiprothrin, inabenfide, indanofan, indaziflam, indoxacarb, inezin, iodobonil, iodocarb, iodomethane, iodosulfuron, iodosulfuron-methyl, iodosulfuron-methyl-sodium, iofensulfuron, iofensulfuron-sodium, ioxynil, ioxynil octanoate, ioxynil-lithium, ioxynil-sodium, ipazine, ipconazole, ipfencarbazone, iprobenfos, iprodione, iprovalicarb, iprymidam, ipsdienol, ipsenol, IPSP, isamidofos, isazofos, isobenzan, isocarbamid, isocarbophos, isocil, isodrin, isofenphos, isofenphos-methyl, isolan, isomethiozin, isonoruron, isopolinate, isoprocarb, isopropalin, isoprothiolane, isoproturon, isopyrazam, isopyrimol, isothioate, isotianil, isouron, isovaledione, isoxaben, isoxachlortole, isoxadifen, isoxadifen-ethyl, isoxaflutole, isoxapyrifop, isoxathion, ivermectin, izopamfos, japonilure, japothrins, jasmolin I, jasmolin II, jasmonic acid, jiahuangchongzong, jiajizengxiaolin, jiaxiangjunzhi, jiecaowan, jiecaoxi, jodfenphos, juvenile hormone I, juvenile hormone II, juvenile hormone III, kadethrin, karbutilate, karetazan, karetazan-potassium, kasugamycin, kasugamycin hydrochloride, kejunlin, kelevan, ketospiradox, ketospiradox-potassium, kinetin, kinoprene, kresoxim-methyl, kuicaoxi, lactofen, lambda-cyhalothrin, latilure, lead arsenate, lenacil, lepimectin, leptophos, lindane, lineatin, linuron, lirimfos, litlure, looplure, lufenuron, lvdingjunzhi, Ivxiancaolin, lythidathion, MAA, malathion, maleic hydrazide, malonoben, maltodextrin, MAMA, mancopper, mancozeb, mandipropamid, maneb, matrine, mazidox, MCPA, MCPA-2-ethylhexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-potassium, MCPA-sodium, MCPA-thioethyl, MCPA-trolamine, MCPB, MCPB-ethyl, MCPB-methyl, MCPB-sodium, mebenil, mecarbam, mecarbinzid, mecarphon, mecoprop, mecoprop-2-ethylhexyl, mecoprop-dimethylammonium, mecoprop-diolamine, mecoprop-ethadyl, mecoprop-isoctyl, mecoprop-methyl, mecoprop-P, mecoprop-P-2-ethylhexyl, mecoprop-P-dimethylammonium, mecoprop-P-isobutyl, mecoprop-potassium, mecoprop-P-potassium, mecoprop-sodium, mecoprop-trolamine, medimeform, medinoterb, medinoterb acetate, medlure, mefenacet, mefenpyr, mefenpyr-diethyl, mefluidide, mefluidide-diolamine, mefluidide-potassium, megatomoic acid, menazon, mepanipyrim, meperfluthrin, mephenate, mephosfolan, mepiquat, mepiquat chloride, mepiquat pentaborate, mepronil, meptyldinocap, mercuric chloride, mercuric oxide, mercurous chloride, merphos, mesoprazine, mesosulfuron, mesosulfuron-methyl, mesotrione, mesulfen, mesulfenfos, metaflumizone, metalaxyl, metalaxyl-M, metaldehyde, metam, metam-ammonium, metamifop, metamitron, metam-potassium, metam-sodium, metazachlor, metazosulfuron, metazoxolon, metconazole, metepa, metflurazon, methabenzthiazuron, methacrifos, methalpropalin, methamidophos, methasulfocarb, methazole, methfuroxam, methidathion, methiobencarb, methiocarb, methiopyrisulfuron, methiotepa, methiozolin, methiuron, methocrotophos, methometon, methomyl, methoprene, methoprotryne, methoquin-butyl, methothrin, methoxychlor, methoxyfenozide, methoxyphenone, methyl apholate, methyl bromide, methyl eugenol, methyl iodide, methyl isothiocyanate, methylacetophos, methylchloroform, methyldymron, methylene chloride, methylmercury benzoate, methylmercury dicyandiamide, methylmercury pentachlorophenoxide, methylneodecanamide, metiram, metobenzuron, metobromuron, metofluthrin, metolachlor, metolcarb, metominostrobin, metosulam, metoxadiazone, metoxuron, metrafenone, metribuzin, metsulfovax, metsulfuron, metsulfuron-methyl, mevinphos, mexacarbate, mieshuan, milbemectin, milbemycin oxime, milneb, mipafox, mirex, MNAF, moguchun, molinate, molosultap, monalide, monisouron, monochloroacetic acid, monocrotophos, monolinuron, monosulfuron, monosulfuron-ester, monuron, monuron TCA, morfamquat, morfamquat dichloride, moroxydine, moroxydine hydrochloride, morphothion, morzid, moxidectin, MSMA, muscalure, myclobutanil, myclozolin, N-(ethylmercury)-p-toluenesulphonanilide, nabam, naftalofos, naled, naphthalene, naphthaleneacetamide, naphthalic anhydride, naphthoxyacetic acids, naproanilide, napropamide, naptalam, naptalam-sodium, natamycin, neburon, niclosamide, niclosamide-olamine, nicosulfuron, nicotine, nifluridide, nipyraclofen, nitenpyram, nithiazine, nitralin, nitrapyrin, nitrilacarb, nitrofen, nitrofluorfen, nitrostyrene, nitrothal-isopropyl, norbormide, norflurazon, nornicotine, noruron, novaluron, noviflumuron, nuarimol, OCH, octachlorodipropyl ether, octhilinone, ofurace, omethoate, orbencarb, orfralure, ortho-dichlorobenzene, orthosulfamuron, oryctalure, orysastrobin, oryzalin, osthol, ostramone, oxabetrinil, oxadiargyl, oxadiazon, oxadixyl, oxamate, oxamyl, oxapyrazon, oxapyrazon-dimolamine, oxapyrazon-sodium, oxasulfuron, oxaziclomefone, oxine-copper, oxolinic acid, oxpoconazole, oxpoconazole fumarate, oxycarboxin, oxydemeton-methyl, oxydeprofos, oxydisulfoton, oxyfluorfen, oxymatrine, oxytetracycline, oxytetracycline hydrochloride, paclobutrazol, paichongding, para-dichlorobenzene, parafluron, paraquat, paraquat dichloride, paraquat dimetilsulfate, parathion, parathion-methyl, parinol, pebulate, pefurazoate, pelargonic acid, penconazole, pencycuron, pendimethalin, penflufen, penfluron, penoxsulam, pentachlorophenol, pentanochlor, penthiopyrad, pentmethrin, pentoxazone, perfluidone, permethrin, pethoxamid, phenamacril, phenazine oxide, phenisopham, phenkapton, phenmedipham, phenmedipham-ethyl, phenobenzuron, phenothrin, phenproxide, phenthoate, phenylmercuriurea, phenylmercury acetate, phenylmercury chloride, phenylmercury derivative of pyrocatechol, phenylmercury nitrate, phenylmercury salicylate, phorate, phosacetim, phosalone, phosdiphen, phosfolan, phosfolan-methyl, phosglycin, phosmet, phosnichlor, phosphamidon, phosphine, phosphocarb, phosphorus, phostin, phoxim, phoxim-methyl, phthalide, picloram, picloram-2-ethylhexyl, picloram-isoctyl, picloram-methyl, picloram-olamine, picloram-potassium, picloram-triethylammonium, picloram-tris(2-hydroxypropyl)ammonium, picolinafen, picoxystrobin, pindone, pindone-sodium, pinoxaden, piperalin, piperonyl butoxide, piperonyl cyclonene, piperophos, piproctanyl, piproctanyl bromide, piprotal, pirimetaphos, pirimicarb, pirimioxyphos, pirimiphos-ethyl, pirimiphos-methyl, plifenate, polycarbamate, polyoxins, polyoxorim, polyoxorim-zinc, polythialan, potassium arsenite, potassium azide, potassium cyanate, potassium gibberellate, potassium naphthenate, potassium polysulfide, potassium thiocyanate, potassium α-naphthaleneacetate, pp′-DDT, prallethrin, precocene I, precocene II, precocene III, pretilachlor, primidophos, primisulfuron, primisulfuron-methyl, probenazole, prochloraz, prochloraz-manganese, proclonol, procyazine, procymidone, prodiamine, profenofos, profluazol, profluralin, profluthrin, profoxydim, proglinazine, proglinazine-ethyl, prohexadione, prohexadione-calcium, prohydrojasmon, promacyl, promecarb, prometon, prometryn, promurit, propachlor, propamidine, propamidine dihydrochloride, propamocarb, propamocarb hydrochloride, propanil, propaphos, propaquizafop, propargite, proparthrin, propazine, propetamphos, propham, propiconazole, propineb, propisochlor, propoxur, propoxycarbazone, propoxycarbazone-sodium, propyl isome, propyrisulfuron, propyzamide, proquinazid, prosuler, prosulfalin, prosulfocarb, prosulfuron, prothidathion, prothiocarb, prothiocarb hydrochloride, prothioconazole, prothiofos, prothoate, protrifenbute, proxan, proxan-sodium, prynachlor, pydanon, pymetrozine, pyracarbolid, pyraclofos, pyraclonil, pyraclostrobin, pyraflufen, pyraflufen-ethyl, pyrafluprole, pyramat, pyrametostrobin, pyraoxystrobin, pyrasulfotole, pyrazolynate, pyrazophos, pyrazosulfuron, pyrazosulfuron-ethyl, pyrazothion, pyrazoxyfen, pyresmethrin, pyrethrin I, pyrethrin II, pyrethrins, pyribambenz-isopropyl, pyribambenz-propyl, pyribencarb, pyribenzoxim, pyributicarb, pyriclor, pyridaben, pyridafol, pyridalyl, pyridaphenthion, pyridate, pyridinitril, pyrifenox, pyrifluquinazon, pyriftalid, pyrimethanil, pyrimidifen, pyriminobac, pyriminobac-methyl, pyrimisulfan, pyrimitate, pyrinuron, pyriofenone, pyriprole, pyripropanol, pyriproxyfen, pyrithiobac, pyrithiobac-sodium, pyrolan, pyroquilon, pyroxasulfone, pyroxsulam, pyroxychlor, pyroxyfur, quassia, quinacetol, quinacetol sulfate, quinalphos, quinalphos-methyl, quinazamid, quinclorac, quinconazole, quinmerac, quinoclamine, quinonamid, quinothion, quinoxyfen, quintiofos, quintozene, quizalofop, quizalofop-ethyl, quizalofop-P, quizalofop-P-ethyl, quizalofop-P-tefuryl, quwenzhi, quyingding, rabenzazole, rafoxanide, rebemide, resmethrin, rhodethanil, rhodojaponin-III, ribavirin, rimsulfuron, rotenone, ryania, saflufenacil, saijunmao, saisentong, salicylanilide, sanguinarine, santonin, schradan, scilliroside, sebuthylazine, secbumeton, sedaxane, selamectin, semiamitraz, semiamitraz chloride, sesamex, sesamolin, sethoxydim, shuangjiaancaolin, siduron, siglure, silafluofen, silatrane, silica gel, silthiofam, simazine, simeconazole, simeton, simetryn, sintofen, SMA, S-metolachlor, sodium arsenite, sodium azide, sodium chlorate, sodium fluoride, sodium fluoroacetate, sodium hexafluorosilicate, sodium naphthenate, sodium orthophenylphenoxide, sodium pentachlorophenoxide, sodium polysulfide, sodium thiocyanate, sodium α-naphthaleneacetate, sophamide, spinetoram, spinosad, spirodiclofen, spiromesifen, spirotetramat, spiroxamine, streptomycin, streptomycin sesquisulfate, strychnine, sulcatol, sulcofuron, sulcofuron-sodium, sulcotrione, sulfallate, sulfentrazone, sulfiram, sulfluramid, sulfometuron, sulfometuron-methyl, sulfosulfuron, sulfotep, sulfoxaflor, sulfoxide, sulfoxime, sulfur, sulfuric acid, sulfuryl fluoride, sulglycapin, sulprofos, sultropen, swep, tau-fluvalinate, tavron, tazimcarb, TCA, TCA-ammonium, TCA-calcium, TCA-ethadyl, TCA-magnesium, TCA-sodium, TDE, tebuconazole, tebufenozide, tebufenpyrad, tebufloquin, tebupirimfos, tebutam, tebuthiuron, tecloftalam, tecnazene, tecoram, teflubenzuron, tefluthrin, tefuryltrione, tembotrione, temephos, tepa, TEPP, tepraloxydim, terallethrin, terbacil, terbucarb, terbuchlor, terbufos, terbumeton, terbuthylazine, terbutryn, tetcyclacis, tetrachloroethane, tetrachlorvinphos, tetraconazole, tetradifon, tetrafluron, tetramethrin, tetramethylfluthrin, tetramine, tetranactin, tetrasul, thallium sulfate, thenylchlor, theta-cypermethrin, thiabendazole, thiacloprid, thiadifluor, thiamethoxam, thiapronil, thiazafluron, thiazopyr, thicrofos, thicyofen, thidiazimin, thidiazuron, thiencarbazone, thiencarbazone-methyl, thifensulfuron, thifensulfuron-methyl, thifluzamide, thiobencarb, thiocarboxime, thiochlorfenphim, thiocyclam, thiocyclam hydrochloride, thiocyclam oxalate, thiodiazole-copper, thiodicarb, thiofanox, thiofluoximate, thiohempa, thiomersal, thiometon, thionazin, thiophanate, thiophanate-methyl, thioquinox, thiosemicarbazide, thiosultap, thiosultap-diammonium, thiosultap-disodium, thiosultap-monosodium, thiotepa, thiram, thuringiensin, tiadinil, tiaojiean, tiocarbazil, tioclorim, tioxymid, tirpate, tolclofos-methyl, tolfenpyrad, tolylfluanid, tolylmercury acetate, topramezone, tralkoxydim, tralocythrin, tralomethrin, tralopyril, transfluthrin, transpermethrin, tretamine, triacontanol, triadimefon, triadimenol, triafamone, tri-allate, triamiphos, triapenthenol, triarathene, triarimol, triasulfuron, triazamate, triazbutil, triaziflam, triazophos, triazoxide, tribenuron, tribenuron-methyl, tribufos, tributyltin oxide, tricamba, trichlamide, trichlorfon, trichlormetaphos-3, trichloronat, triclopyr, triclopyr-butotyl, triclopyr-ethyl, triclopyr-triethylammonium, tricyclazole, tridemorph, tridiphane, trietazine, trifenmorph, trifenofos, trifloxystrobin, trifloxysulfuron, trifloxysulfuron-sodium, triflumizole, triflumuron, trifluralin, triflusulfuron, triflusulfuron-methyl, trifop, trifop-methyl, trifopsime, triforine, trihydroxytriazine, trimedlure, trimethacarb, trimeturon, trinexapac, trinexapac-ethyl, triprene, tripropindan, triptolide, tritac, triticonazole, tritosulfuron, trunc-call, uniconazole, uniconazole-P, urbacide, uredepa, valerate, validamycin, valifenalate, valone, vamidothion, vangard, vaniliprole, vernolate, vinclozolin, warfarin, warfarin-potassium, warfarin-sodium, xiaochongliulin, xinjunan, xiwojunan, XMC, xylachlor, xylenols, xylylcarb, yishijing, zarilamid, zeatin, zengxiaoan, zeta-cypermethrin, zinc naphthenate, zinc phosphide, zinc thiazole, zineb, ziram, zolaprofos, zoxamide, zuomihuanglong, α-chlorohydrin, α-ecdysone, α-multistriatin, and 60 -naphthaleneacetic acid.

8. The method of claim 1, wherein the at least one pesticide is indaziflam.

9. The method of claim 1, wherein the pesticide is applied to treat the soil/growing media within which is grown a plant that is at least one selected from the group consisting of Bushberries, Caneberries, Blackberries, Loganberries, Blueberries, High bush blueberries, Cranberries, Currants, Elderberry, Gooseberries, Grapes, Vineyards, Huckleberries, Red raspberries, Black raspberries, Juneberries, Citrus (Citron, Grapefruit, Kumquat, Lemons, Limes, Oranges, Tangelos, Mandarin orange, Satsuma mandarin, Mandarin, Tangerines, Tangor, Calamondin, Chironja, Sweet oranges, Sour oranges, Pummelo), Nut trees (Nonbearing nut trees, Almonds, Brazil nut, Cashews, Chestnuts, Chinquapin, Hazelnut, Filberts, Hickory nuts, Macadamia nuts, Pecans, English walnuts, Butternuts, Pistachio nuts, Black Walnut, Beech nut), Pome fruits (Apples, Crabapples, Pears, Quinces), Stone fruits (Tart cherries, Sweet cherries, Nectarines, Peaches, Plums, Chickasaw plums, Damson plums, Japanese plums, Prunes), Coconut, Loquat, Ginkgo nut, Coffee, Hops, Pine nuts, Asparagus fern, Switchgrass, Big bluestem, Olives, Orchards, Non-bearing fruit trees, Hardwood trees, Conifers, Conifer plantings, Christmas tree plantings, Shelterbelts, Forests (Ash, Cottonwood, Maple, Oak, Sweetgum, Sycamore, Loblolly pine, Longleaf pine, Slash pine, Shortleaf pine, Virginia pine), Cottonwood/Poplar hybrids, Aster, Bleeding-heart, Daylilies, Gold-dust, Verbena, Purple passion vine, Hosta, Ornamental plants, Nursery ornamental plants, Ornamental evergreens, Containerized ornamental evergreens, Ornamental turf (Golf course lawns, Golf courses, Golf course rough, Golf fairways, Golf tees, Parks, Athletic fields, Cemeteries, Commericial turf, Turf grown for sod, Warm season turf, Lawns), Bahiagrass (Golf courses, Athletic fields, Lawns, Ornamental turf), Bermudagrass (Golf courses, Lawns, Ornamental turf, Athletic fields), Buffalograss (Golf courses, Lawns, Ornamental turf, Athletic fields), Centipedegrass (Golf courses, Lawns, Ornamental turf, Athletic fields), Kentucky bluegrass, St. Augustinegrass (Golf courses, Lawns, Ornamental turf, Athletic fields), Zoysiagrass (Golf course, Athletic fields, Lawns, Ornamental turf), Seashore paspalum (Ornamental turf), Ornamntal broadleaf evergreen shrubs (Abelia, Azalea, Beauty bush, Bougainvillea, Boxwood, Camellia, Cherry Laurel, Cotoneater), Crape myrtle, Daphne Forsytia, Gardenia, Rose of Sharon-Red bird, Hibiscus, Honeysuckle, Indian hawthorn, Lantana, Privet, Lilac, Mock-orange, Nandina, Periwinkle, Pittosporum, Potentilla, Roses, Snowberry, Viburnum, Wax-myrtle, Weigela, Butterfly bush, Chinese hibiscus, Chinese holly, Gallberry, Pussy willow, Cleyera japonica, Rose-of-Sharon, Silverberry, Winter jasmine, Japanese camellia, Yellow star-jasmine, Siberian dogwood, Slender deutzia, Asiatic jasmine, Ornamental trees, Deciduous ornamental trees, American elm, American sycamore, Arborvitae, Catalpa, False cypress, Cypress, American dogwood, Dogwood, Elm, Almond (Ornamental), Cherry (Ornamental), Crabapple (Ornamental), Green ash, Linden, Magnolia, Podocarpus, Russian olive, Sugar maple, American sweetgum, Sweetgum, Sycamore, Tupelo (Nursery), White cedar, Willow, Yew, Red maple, Blue Pacific, Weeping willows, Bar harbor juniper, Blue rug juniper, Serviceberry, Sweet olive, Greenhouse plant beds.

10. A composition that is resistant to downward migration when applied to soil, turf, a plant or surrounding environment, said composition comprising a pesticide, a solvent, a polymeric emulsifier(s), and optionally one or more additives, antifoam agents, antimicrobial agents and optionally balance water, wherein at least said herbicide and said solvent are in an oil in water emulsion or emulsifiable concentrate and said herbicide is optionally completely dissolved in said solvent.

11. The composition of claim 10, wherein said one or more additives are included, and said additives are capable of serving as intermediaries between the herbicide and organic matters in the soil, forming a three-way interaction to enhance the immobility of the active ingredient in soil.

12. The composition of claim 11, wherein said additives comprise one or more long chain alcohols, cellulosic materials, polycarboxylates, polymers, or oligosaccharides.

13. The composition of claim 12, which comprises a pesticide from 0.1 to 10%, long chain di-substituted amide solvent from 10 to 80%, polymeric emulsifier(s) from 0.1 to 15%, additives from 0 to 20%, antifoam agent from 0 to20%, antimicrobial agent from 0 to 20%, and water from 10 to 80%.

14. The composition of claim 12, which comprises a pesticide from 0.1 to 10%, long chain di-substituted amide solvent from 10 to 80%, polymeric emulsifier(s) from 0.1 to 15%, additives from 0 to 20%, antifoam agent from 0 to20%, and antimicrobial agent from 0 to 20%.

15. The composition of claim 13, wherein said herbicide comprises indaziflam.

16. The composition of claim 10, wherein the pesticide is at least one selected from the group consisting of (3-ethoxypropyl)mercury bromide, 1,2-dichloropropane, 1,3-dichloropropene, 1-methylcyclopropene, 1-naphthol, 2-(octylthio)ethanol, 2,3,5-tri-iodobenzoic acid, 2,3,6-TBA, 2,3,6-TBA-dimethylammonium, 2,3,6-TBA-lithium, 2,3,6-TBA-potassium, 2,3,6-TBA-sodium, 2,4,5-T, 2,4,5-T-2-butoxypropyl, 2,4,5-T-2-ethylhexyl, 2,4,5-T-3-butoxypropyl, 2,4,5-TB, 2,4,5-T-butometyl, 2,4,5-T-butotyl, 2,4,5-T-butyl, 2,4,5-T-isobutyl, 2,4,5-T-isoctyl, 2,4,5-T-isopropyl, 2,4,5-T-methyl, 2,4,5-T-pentyl, 2,4,5-T-sodium, 2,4,5-T-triethylammonium, 2,4,5-T-trolamine, 2,4-D, 2,4-D-2-butoxypropyl, 2,4-D-2-ethylhexyl, 2,4-D-3-butoxypropyl, 2,4-D-ammonium, 2,4-DB, 2,4-DB-butyl, 2,4-DB-dimethylammonium, 2,4-DB-isoctyl, 2,4-DB-potassium, 2,4-DB-sodium, 2,4-D-butotyl, 2,4-D-butyl, 2,4-D-diethylammonium, 2,4-D-dimethylammonium, 2,4-D-diolamine, 2,4-D-dodecylammonium, 2,4-DEB, 2,4-DEP, 2,4-D-ethyl, 2,4-D-heptylammonium, 2,4-D-isobutyl, 2,4-D-isoctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-potassium, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 2iP, 2-methoxyethylmercury chloride, 2-phenylphenol, 3,4-DA, 3,4-DB, 3,4-DP, 4-aminopyridine, 4-CPA, 4-CPA-potassium, 4-CPA-sodium, 4-CPB, 4-CPP, 4-hydroxyphenethyl alcohol, 8-hydroxyquinoline sulfate, 8-phenylmercurioxyquinoline, abamectin, abscisic acid, ACC, acephate, acequinocyl, acetamiprid, acethion, acetochlor, acetophos, acetoprole, acibenzolar, acibenzolar-S-methyl, acifluorfen, acifluorfen-methyl, acifluorfen-sodium, aclonifen, acrep, acrinathrin, acrolein, acrylonitrile, acypetacs, acypetacs-copper, acypetacs-zinc, alachlor, alanycarb, albendazole, aldicarb, aldimorph, aldoxycarb, aldrin, allethrin, allicin, allidochlor, allosamidin, alloxydim, alloxydim-sodium, allyl alcohol, allyxycarb, alorac, alpha-cypermethrin, alpha-endosulfan, ametoctradin, ametridione, ametryn, amibuzin, amicarbazone, amicarthiazol, amidithion, amidoflumet, amidosulfuron, aminocarb, aminocyclopyrachlor, aminocyclopyrachlor-methyl, aminocyclopyrachlor-potassium, aminopyralid, aminopyralid-potassium, aminopyralid-tris(2-hydroxypropyl)ammonium, amiprofos-methyl, amiprophos, amisulbrom, amiton, amiton oxalate, amitraz, amitrole, ammonium sulfamate, ammonium α-naphthaleneacetate, amobam, ampropylfos, anabasine, ancymidol, anilazine, anilofos, anisuron, anthraquinone, antu, apholate, aramite, arsenous oxide, asomate, aspirin, asulam, asulam-potassium, asulam-sodium, athidathion, atraton, atrazine, aureofungin, aviglycine, aviglycine hydrochloride, azaconazole, azadirachtin, azafenidin, azamethiphos, azimsulfuron, azinphos-ethyl, azinphos-methyl, aziprotryne, azithiram, azobenzene, azocyclotin, azothoate, azoxystrobin, bachmedesh, barban, barium hexafluorosilicate, barium polysulfide, barthrin, BCPC, beflubutamid, benalaxyl, benalaxyl-M, benazolin, benazolin-dimethylammonium, benazolin-ethyl, benazolin-potassium, bencarbazone, benclothiaz, bendiocarb, benfluralin, benfuracarb, benfuresate, benodanil, benomyl, benoxacor, benoxafos, benquinox, bensulfuron, bensulfuron-methyl, bensulide, bensultap, bentaluron, bentazone, bentazone-sodium, benthiavalicarb, benthiavalicarb-isopropyl, benthiazole, bentranil, benzadox, benzadox-ammonium, benzalkonium chloride, benzamacril, benzamacril-isobutyl, benzamorf, benzfendizone, benzipram, benzobicyclon, benzofenap, benzofluor, benzohydroxamic acid, benzoximate, benzoylprop, benzoylprop-ethyl, benzthiazuron, benzyl benzoate, benzyladenine, berberine, berberine chloride, beta-cyfluthrin, beta-cypermethrin, bethoxazin, bicyclopyrone, bifenazate, bifenox, bifenthrin, bifujunzhi, bilanafos, bilanafos-sodium, binapacryl, bingqingxiao, bioallethrin, bioethanomethrin, biopermethrin, bioresmethrin, biphenyl, bisazir, bismerthiazol, bispyribac, bispyribac-sodium, bistrifluron, bitertanol, bithionol, bixafen, blasticidin-S, borax, Bordeaux mixture, boric acid, boscalid, brassinolide, brassinolide-ethyl, brevicomin, brodifacoum, brofenvalerate, brofluthrinate, bromacil, bromacil-lithium, bromacil-sodium, bromadiolone, bromethalin, bromethrin, bromfenvinfos, bromoacetamide, bromobonil, bromobutide, bromocyclen, bromo-DDT, bromofenoxim, bromophos, bromophos-ethyl, bromopropylate, bromothalonil, bromoxynil, bromoxynil butyrate, bromoxynil heptanoate, bromoxynil octanoate, bromoxynil-potassium, brompyrazon, bromuconazole, bronopol, bucarpolate, bufencarb, buminafos, bupirimate, buprofezin, Burgundy mixture, busulfan, butacarb, butachlor, butafenacil, butamifos, butathiofos, butenachlor, butethrin, buthidazole, buthiobate, buthiuron, butocarboxim, butonate, butopyronoxyl, butoxycarboxim, butralin, butroxydim, buturon, butylamine, butylate, cacodylic acid, cadusafos, cafenstrole, calcium arsenate, calcium chlorate, calcium cyanamide, calcium polysulfide, calvinphos, cambendichlor, camphechlor, camphor, captafol, captan, carbamorph, carbanolate, carbaryl, carbasulam, carbendazim, carbendazim benzenesulfonate, carbendazim sulfite, carbetamide, carbofuran, carbon disulfide, carbon tetrachloride, carbophenothion, carbosulfan, carboxazole, carboxide, carboxin, carfentrazone, carfentrazone-ethyl, carpropamid, cartap, cartap hydrochloride, carvacrol, carvone, CDEA, cellocidin, CEPC, ceralure, Cheshunt mixture, chinomethionat, chitosan, chlobenthiazone, chlomethoxyfen, chloralose, chloramben, chloramben-ammonium, chloramben-diolamine, chloramben-methyl, chloramben-methylammonium, chloramben-sodium, chloramine phosphorus, chloramphenicol, chloraniformethan, chloranil, chloranocryl, chlorantraniliprole, chlorazifop, chlorazifop-propargyl, chlorazine, chlorbenside, chlorbenzuron, chlorbicyclen, chlorbromuron, chlorbufam, chlordane, chlordecone, chlordimeform, chlordimeform hydrochloride, chlorempenthrin, chlorethoxyfos, chloreturon, chlorfenac, chlorfenac-ammonium, chlorfenac-sodium, chlorfenapyr, chlorfenazole, chlorfenethol, chlorfenprop, chlorfenson, chlorfensulphide, chlorfenvinphos, chlorfluazuron, chlorflurazole, chlorfluren, chlorfluren-methyl, chlorflurenol, chlorflurenol-methyl, chloridazon, chlorimuron, chlorimuron-ethyl, chlormephos, chlormequat, chlormequat chloride, chlornidine, chlornitrofen, chlorobenzilate, chlorodinitronaphthalenes, chloroform, chloromebuform, chloromethiuron, chloroneb, chlorophacinone, chlorophacinone-sodium, chloropicrin, chloropon, chloropropylate, chlorothalonil, chlorotoluron, chloroxuron, chloroxynil, chlorphonium, chlorphonium chloride, chlorphoxim, chlorprazophos, chlorprocarb, chlorpropham, chlorpyrifos, chlorpyrifos-methyl, chlorquinox, chlorsulfuron, chlorthal, chlorthal-dimethyl, chlorthal-monomethyl, chlorthiamid, chlorthiophos, chlozolinate, choline chloride, chromafenozide, cinerin I, cinerin II, cinerins, cinidon-ethyl, cinmethylin, cinosulfuron, ciobutide, cisanilide, cismethrin, clethodim, climbazole, cliodinate, clodinafop, clodinafop-propargyl, cloethocarb, clofencet, clofencet-potassium, clofentezine, clofibric acid, clofop, clofop-isobutyl, clomazone, clomeprop, cloprop, cloproxydim, clopyralid, clopyralid-methyl, clopyralid-olamine, clopyralid-potassium, clopyralid-tris(2-hydroxypropyl)ammonium, cloquintocet, cloquintocet-mexyl, cloransulam, cloransulam-methyl, closantel, clothianidin, clotrimazole, cloxyfonac, cloxyfonac-sodium, CMA, codlelure, colophonate, copper acetate, copper acetoarsenite, copper arsenate, copper carbonate, basic, copper hydroxide, copper naphthenate, copper oleate, copper oxychloride, copper silicate, copper sulfate, copper zinc chromate, coumachlor, coumafuryl, coumaphos, coumatetralyl, coumithoate, coumoxystrobin, CPMC, CPMF, CPPC, credazine, cresol, crimidine, crotamiton, crotoxyphos, crufomate, cryolite, cue-lure, cufraneb, cumyluron, cuprobam, cuprous oxide, curcumenol, cyanamide, cyanatryn, cyanazine, cyanofenphos, cyanophos, cyanthoate, cyantraniliprole, cyazofamid, cybutryne, cyclafuramid, cyclanilide, cyclethrin, cycloate, cycloheximide, cycloprate, cycloprothrin, cyclosulfamuron, cycloxydim, cycluron, cyenopyrafen, cyflufenamid, cyflumetofen, cyfluthrin, cyhalofop, cyhalofop-butyl, cyhalothrin, cyhexatin, cymiazole, cymiazole hydrochloride, cymoxanil, cyometrinil, cypendazole, cypermethrin, cyperquat, cyperquat chloride, cyphenothrin, cyprazine, cyprazole, cyproconazole, cyprodinil, cyprofuram, cypromid, cyprosulfamide, cyromazine, cythioate, daimuron, dalapon, dalapon-calcium, dalapon-magnesium, dalapon-sodium, daminozide, dayoutong, dazomet, dazomet-sodium, DBCP, d-camphor, DCIP, DCPTA, DDT, debacarb, decafentin, decarbofuran, dehydroacetic acid, delachlor, deltamethrin, demephion, demephion-O, demephion-S, demeton, demeton-methyl, demeton-O, demeton-O-methyl, demeton-S, demeton-S-methyl, demeton-S-methylsulphon, desmedipham, desmetryn, d-fanshiluquebingjuzhi, diafenthiuron, dialifos, di-allate, diamidafos, diatomaceous earth, diazinon, dibutyl phthalate, dibutyl succinate, dicamba, dicamba-diglycolamine, dicamba-dimethylammonium, dicamba-diolamine, dicamba-isopropylammonium, dicamba-methyl, dicamba-olamine, dicamba-potassium, dicamba-sodium, dicamba-trolamine, dicapthon, dichlobenil, dichlofenthion, dichlofluanid, dichlone, dichloralurea, dichlorbenzuron, dichlorflurenol, dichlorflurenol-methyl, dichlormate, dichlormid, dichlorophen, dichlorprop, dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P-2-ethylhexyl, dichlorprop-P-dimethylammonium, dichlorprop-potassium, dichlorprop-sodium, dichlorvos, dichlozoline, diclobutrazol, diclocymet, diclofop, diclofop-methyl, diclomezine, diclomezine-sodium, dicloran, diclosulam, dicofol, dicoumarol, dicresyl, dicrotophos, dicyclanil, dicyclonon, dieldrin, dienochlor, diethamquat, diethamquat dichloride, diethatyl, diethatyl-ethyl, diethofencarb, dietholate, diethyl pyrocarbonate, diethyltoluamide, difenacoum, difenoconazole, difenopenten, difenopenten-ethyl, difenoxuron, difenzoquat, difenzoquat metilsulfate, difethialone, diflovidazin, diflubenzuron, diflufenican, diflufenzopyr, diflufenzopyr-sodium, diflumetorim, dikegulac, dikegulac-sodium, dilor, dimatif, dimefluthrin, dimefox, dimefuron, dimepiperate, dimetachlone, dimetan, dimethacarb, dimethachlor, dimethametryn, dimethenamid, dimethenamid-P, dimethipin, dimethirimol, dimethoate, dimethomorph, dimethrin, dimethyl carbate, dimethyl phthalate, dimethylvinphos, dimetilan, dimexano, dimidazon, dimoxystrobin, dinex, dinex-diclexine, dingjunezuo, diniconazole, diniconazole-M, dinitramine, dinobuton, dinocap, dinocap-4, dinocap-6, dinocton, dinofenate, dinopenton, dinoprop, dinosam, dinoseb, dinoseb acetate, dinoseb-ammonium, dinoseb-diolamine, dinoseb-sodium, dinoseb-trolamine, dinosulfon, dinotefuran, dinoterb, dinoterb acetate, dinoterbon, diofenolan, dioxabenzofos, dioxacarb, dioxathion, diphacinone, diphacinone-sodium, diphenamid, diphenyl sulfone, diphenylamine, dipropalin, dipropetryn, dipyrithione, diquat, diquat dibromide, disparlure, disul, disulfiram, disulfoton, disul-sodium, ditalimfos, dithianon, dithicrofos, dithioether, dithiopyr, diuron, d-limonene, DMPA, DNOC, DNOC-ammonium, DNOC-potassium, DNOC-sodium, dodemorph, dodemorph acetate, dodemorph benzoate, dodicin, dodicin hydrochloride, dodicin-sodium, dodine, dofenapyn, dominicalure, doramectin, drazoxolon, DSMA, dufulin, EBEP, EBP, ecdysterone, edifenphos, eglinazine, eglinazine-ethyl, emamectin, emamectin benzoate, EMPC, empenthrin, endosulfan, endothal, endothal-diammonium, endothal-dipotassium, endothal-disodium, endothion, endrin, enestroburin, EPN, epocholeone, epofenonane, epoxiconazole, eprinomectin, epronaz, EPTC, erbon, ergocalciferol, erlujixiancaoan, esdépalléthrine, esfenvalerate, esprocarb, etacelasil, etaconazole, etaphos, etem, ethaboxam, ethachlor, ethalfluralin, ethametsulfuron, ethametsulfuron-methyl, ethaprochlor, ethephon, ethidimuron, ethiofencarb, ethiolate, ethion, ethiozin, ethiprole, ethirimol, ethoate-methyl, ethofumesate, ethohexadiol, ethoprophos, ethoxyfen, ethoxyfen-ethyl, ethoxyquin, ethoxysulfuron, ethychlozate, ethyl formate, ethyl α-naphthaleneacetate, ethyl-DDD, ethylene, ethylene dibromide, ethylene dichloride, ethylene oxide, ethylicin, ethylmercury 2,3-dihydroxypropyl mercaptide, ethylmercury acetate, ethylmercury bromide, ethylmercury chloride, ethylmercury phosphate, etinofen, etnipromid, etobenzanid, etofenprox, etoxazole, etridiazole, etrimfos, eugenol, EXD, famoxadone, famphur, fenamidone, fenaminosulf, fenamiphos, fenapanil, fenarimol, fenasulam, fenazaflor, fenazaquin, fenbuconazole, fenbutatin oxide, fenchlorazole, fenchlorazole-ethyl, fenchlorphos, fenclorim, fenethacarb, fenfluthrin, fenfuram, fenhexamid, fenitropan, fenitrothion, fenjuntong, fenobucarb, fenoprop, fenoprop-3-butoxypropyl, fenoprop-butometyl, fenoprop-butotyl, fenoprop-butyl, fenoprop-isoctyl, fenoprop-methyl, fenoprop-potassium, fenothiocarb, fenoxacrim, fenoxanil, fenoxaprop, fenoxaprop-ethyl, fenoxaprop-P, fenoxaprop-P-ethyl, fenoxasulfone, fenoxycarb, fenpiclonil, fenpirithrin, fenpropathrin, fenpropidin, fenpropimorph, fenpyrazamine, fenpyroximate, fenridazon, fenridazon-potassium, fenridazon-propyl, fenson, fensulfothion, fenteracol, fenthiaprop, fenthiaprop-ethyl, fenthion, fenthion-ethyl, fentin, fentin acetate, fentin chloride, fentin hydroxide, fentrazamide, fentrifanil, fenuron, fenuron TCA, fenvalerate, ferbam, ferimzone, ferrous sulfate, fipronil, flamprop, flamprop-isopropyl, flamprop-M, flamprop-methyl, flamprop-M-isopropyl, flamprop-M-methyl, flazasulfuron, flocoumafen, flometoquin, flonicamid, florasulam, florpyrauxifen, fluacrypyrim, fluazifop, fluazifop-butyl, fluazifop-methyl, fluazifop-P, fluazifop-P-butyl, fluazinam, fluazolate, fluazuron, flubendiamide, flubenzimine, flucarbazone, flucarbazone-sodium, flucetosulfuron, fluchloralin, flucofuron, flucycloxuron, flucythrinate, fludioxonil, fluenetil, fluensulfone, flufenacet, flufenerim, flufenican, flufenoxuron, flufenprox, flufenpyr, flufenpyr-ethyl, flufiprole, flumethrin, flumetover, flumetralin, flumetsulam, flumezin, flumiclorac, flumiclorac-pentyl, flumioxazin, flumipropyn, flumorph, fluometuron, fluopicolide, fluopyram, fluorbenside, fluoridamid, fluoroacetamide, fluorodifen, fluoroglycofen, fluoroglycofen-ethyl, fluoroimide, fluoromidine, fluoronitrofen, fluothiuron, fluotrimazole, fluoxastrobin, flupoxam, flupropacil, flupropadine, flupropanate, flupropanate-sodium, flupyradifurone, flupyrsulfuron, flupyrsulfuron-methyl, flupyrsulfuron-methyl-sodium, fluquinconazole, flurazole, flurenol, flurenol-butyl, flurenol-methyl, fluridone, flurochloridone, fluroxypyr, fluroxypyr-butometyl, fluroxypyr-meptyl, flurprimidol, flursulamid, flurtamone, flusilazole, flusulfamide, fluthiacet, fluthiacet-methyl, flutianil, flutolanil, flutriafol, fluvalinate, fluxapyroxad, fluxofenim, folpet, fomesafen, fomesafen-sodium, fonofos, foramsulfuron, forchlorfenuron, formaldehyde, formetanate, formetanate hydrochloride, formothion, formparanate, formparanate hydrochloride, fosamine, fosamine-ammonium, fosetyl, fosetyl-aluminium, fosmethilan, fospirate, fosthiazate, fosthietan, frontalin, fuberidazole, fucaojing, fucaomi, funaihecaoling, fuphenthiourea, furalane, furalaxyl, furamethrin, furametpyr, furathiocarb, furcarbanil, furconazole, furconazole-cis, furethrin, furfural, furilazole, furmecyclox, furophanate, furyloxyfen, gamma-cyhalothrin, gamma-HCH, genit, gibberellic acid, gibberellins, gliftor, glufosinate, glufosinate-ammonium, glufosinate-P, glufosinate-P-ammonium, glufosinate-P-sodium, glyodin, glyoxime, glyphosate, glyphosate-diammonium, glyphosate-dimethylammonium, glyphosate-isopropylammonium, glyphosate-monoammonium, glyphosate-potassium, glyphosate-sesquisodium, glyphosate-trimesium, glyphosine, gossyplure, grandlure, griseofulvin, guazatine, guazatine acetates, halacrinate, halauxifen, halfenprox, halofenozide, halosafen, halosulfuron, halosulfuron-methyl, haloxydine, haloxyfop, haloxyfop-etotyl, haloxyfop-methyl, haloxyfop-P, haloxyfop-P-etotyl, haloxyfop-P-methyl, haloxyfop-sodium, HCH, hemel, hempa, HEOD, heptachlor, heptenophos, heptopargil, heterophos, hexachloroacetone, hexachlorobenzene, hexachlorobutadiene, hexachlorophene, hexaconazole, hexaflumuron, hexaflurate, hexalure, hexamide, hexazinone, hexylthiofos, hexythiazox, HHDN, holosulf, huancaiwo, huangcaoling, huanjunzuo, hydramethylnon, hydrargaphen, hydrated lime, hydrogen cyanide, hydroprene, hymexazol, hyquincarb, IAA, IBA, icaridin, imazalil, imazalil nitrate, imazalil sulfate, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazaquin-methyl, imazaquin-sodium, imazethapyr, imazethapyr-ammonium, imazosulfuron, imibenconazole, imicyafos, imidacloprid, imidaclothiz, iminoctadine, iminoctadine triacetate, iminoctadine trialbesilate, imiprothrin, inabenfide, indanofan, indaziflam, indoxacarb, inezin, iodobonil, iodocarb, iodomethane, iodosulfuron, iodosulfuron-methyl, iodosulfuron-methyl-sodium, iofensulfuron, iofensulfuron-sodium, ioxynil, ioxynil octanoate, ioxynil-lithium, ioxynil-sodium, ipazine, ipconazole, ipfencarbazone, iprobenfos, iprodione, iprovalicarb, iprymidam, ipsdienol, ipsenol, IPSP, isamidofos, isazofos, isobenzan, isocarbamid, isocarbophos, isocil, isodrin, isofenphos, isofenphos-methyl, isolan, isomethiozin, isonoruron, isopolinate, isoprocarb, isopropalin, isoprothiolane, isoproturon, isopyrazam, isopyrimol, isothioate, isotianil, isouron, isovaledione, isoxaben, isoxachlortole, isoxadifen, isoxadifen-ethyl, isoxaflutole, isoxapyrifop, isoxathion, ivermectin, izopamfos, japonilure, japothrins, jasmolin I, jasmolin II, jasmonic acid, jiahuangchongzong, jiajizengxiaolin, jiaxiangjunzhi, jiecaowan, jiecaoxi, jodfenphos, juvenile hormone I, juvenile hormone II, juvenile hormone III, kadethrin, karbutilate, karetazan, karetazan-potassium, kasugamycin, kasugamycin hydrochloride, kejunlin, kelevan, ketospiradox, ketospiradox-potassium, kinetin, kinoprene, kresoxim-methyl, kuicaoxi, lactofen, lambda-cyhalothrin, latilure, lead arsenate, lenacil, lepimectin, leptophos, lindane, lineatin, linuron, lirimfos, litlure, looplure, lufenuron, lvdingjunzhi, Ivxiancaolin, lythidathion, MAA, malathion, maleic hydrazide, malonoben, maltodextrin, MAMA, mancopper, mancozeb, mandipropamid, maneb, matrine, mazidox, MCPA, MCPA-2-ethylhexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-potassium, MCPA-sodium, MCPA-thioethyl, MCPA-trolamine, MCPB, MCPB-ethyl, MCPB-methyl, MCPB-sodium, mebenil, mecarbam, mecarbinzid, mecarphon, mecoprop, mecoprop-2-ethylhexyl, mecoprop-dimethylammonium, mecoprop-diolamine, mecoprop-ethadyl, mecoprop-isoctyl, mecoprop-methyl, mecoprop-P, mecoprop-P-2-ethylhexyl, mecoprop-P-dimethylammonium, mecoprop-P-isobutyl, mecoprop-potassium, mecoprop-P-potassium, mecoprop-sodium, mecoprop-trolamine, medimeform, medinoterb, medinoterb acetate, medlure, mefenacet, mefenpyr, mefenpyr-diethyl, mefluidide, mefluidide-diolamine, mefluidide-potassium, megatomoic acid, menazon, mepanipyrim, meperfluthrin, mephenate, mephosfolan, mepiquat, mepiquat chloride, mepiquat pentaborate, mepronil, meptyldinocap, mercuric chloride, mercuric oxide, mercurous chloride, merphos, mesoprazine, mesosulfuron, mesosulfuron-methyl, mesotrione, mesulfen, mesulfenfos, metaflumizone, metalaxyl, metalaxyl-M, metaldehyde, metam, metam-ammonium, metamifop, metamitron, metam-potassium, metam-sodium, metazachlor, metazosulfuron, metazoxolon, metconazole, metepa, metflurazon, methabenzthiazuron, methacrifos, methalpropalin, methamidophos, methasulfocarb, methazole, methfuroxam, methidathion, methiobencarb, methiocarb, methiopyrisulfuron, methiotepa, methiozolin, methiuron, methocrotophos, methometon, methomyl, methoprene, methoprotryne, methoquin-butyl, methothrin, methoxychlor, methoxyfenozide, methoxyphenone, methyl apholate, methyl bromide, methyl eugenol, methyl iodide, methyl isothiocyanate, methylacetophos, methylchloroform, methyldymron, methylene chloride, methylmercury benzoate, methylmercury dicyandiamide, methylmercury pentachlorophenoxide, methylneodecanamide, metiram, metobenzuron, metobromuron, metofluthrin, metolachlor, metolcarb, metominostrobin, metosulam, metoxadiazone, metoxuron, metrafenone, metribuzin, metsulfovax, metsulfuron, metsulfuron-methyl, mevinphos, mexacarbate, mieshuan, milbemectin, milbemycin oxime, milneb, mipafox, mirex, MNAF, moguchun, molinate, molosultap, monalide, monisouron, monochloroacetic acid, monocrotophos, monolinuron, monosulfuron, monosulfuron-ester, monuron, monuron TCA, morfamquat, morfamquat dichloride, moroxydine, moroxydine hydrochloride, morphothion, morzid, moxidectin, MSMA, muscalure, myclobutanil, myclozolin, N-(ethylmercury)-p-toluenesulphonanilide, nabam, naftalofos, naled, naphthalene, naphthaleneacetamide, naphthalic anhydride, naphthoxyacetic acids, naproanilide, napropamide, naptalam, naptalam-sodium, natamycin, neburon, niclosamide, niclosamide-olamine, nicosulfuron, nicotine, nifluridide, nipyraclofen, nitenpyram, nithiazine, nitralin, nitrapyrin, nitrilacarb, nitrofen, nitrofluorfen, nitrostyrene, nitrothal-isopropyl, norbormide, norflurazon, nornicotine, noruron, novaluron, noviflumuron, nuarimol, OCH, octachlorodipropyl ether, octhilinone, ofurace, omethoate, orbencarb, orfralure, ortho-dichlorobenzene, orthosulfamuron, oryctalure, orysastrobin, oryzalin, osthol, ostramone, oxabetrinil, oxadiargyl, oxadiazon, oxadixyl, oxamate, oxamyl, oxapyrazon, oxapyrazon-dimolamine, oxapyrazon-sodium, oxasulfuron, oxaziclomefone, oxine-copper, oxolinic acid, oxpoconazole, oxpoconazole fumarate, oxycarboxin, oxydemeton-methyl, oxydeprofos, oxydisulfoton, oxyfluorfen, oxymatrine, oxytetracycline, oxytetracycline hydrochloride, paclobutrazol, paichongding, para-dichlorobenzene, parafluron, paraquat, paraquat dichloride, paraquat dimetilsulfate, parathion, parathion-methyl, parinol, pebulate, pefurazoate, pelargonic acid, penconazole, pencycuron, pendimethalin, penflufen, penfluron, penoxsulam, pentachlorophenol, pentanochlor, penthiopyrad, pentmethrin, pentoxazone, perfluidone, permethrin, pethoxamid, phenamacril, phenazine oxide, phenisopham, phenkapton, phenmedipham, phenmedipham-ethyl, phenobenzuron, phenothrin, phenproxide, phenthoate, phenylmercuriurea, phenylmercury acetate, phenylmercury chloride, phenylmercury derivative of pyrocatechol, phenylmercury nitrate, phenylmercury salicylate, phorate, phosacetim, phosalone, phosdiphen, phosfolan, phosfolan-methyl, phosglycin, phosmet, phosnichlor, phosphamidon, phosphine, phosphocarb, phosphorus, phostin, phoxim, phoxim-methyl, phthalide, picloram, picloram-2-ethylhexyl, picloram-isoctyl, picloram-methyl, picloram-olamine, picloram-potassium, picloram-triethylammonium, picloram-tris(2-hydroxypropyl)ammonium, picolinafen, picoxystrobin, pindone, pindone-sodium, pinoxaden, piperalin, piperonyl butoxide, piperonyl cyclonene, piperophos, piproctanyl, piproctanyl bromide, piprotal, pirimetaphos, pirimicarb, pirimioxyphos, pirimiphos-ethyl, pirimiphos-methyl, plifenate, polycarbamate, polyoxins, polyoxorim, polyoxorim-zinc, polythialan, potassium arsenite, potassium azide, potassium cyanate, potassium gibberellate, potassium naphthenate, potassium polysulfide, potassium thiocyanate, potassium α-naphthaleneacetate, pp′-DDT, prallethrin, precocene I, precocene II, precocene III, pretilachlor, primidophos, primisulfuron, primisulfuron-methyl, probenazole, prochloraz, prochloraz-manganese, proclonol, procyazine, procymidone, prodiamine, profenofos, profluazol, profluralin, profluthrin, profoxydim, proglinazine, proglinazine-ethyl, prohexadione, prohexadione-calcium, prohydrojasmon, promacyl, promecarb, prometon, prometryn, promurit, propachlor, propamidine, propamidine dihydrochloride, propamocarb, propamocarb hydrochloride, propanil, propaphos, propaquizafop, propargite, proparthrin, propazine, propetamphos, propham, propiconazole, propineb, propisochlor, propoxur, propoxycarbazone, propoxycarbazone-sodium, propyl isome, propyrisulfuron, propyzamide, proquinazid, prosuler, prosulfalin, prosulfocarb, prosulfuron, prothidathion, prothiocarb, prothiocarb hydrochloride, prothioconazole, prothiofos, prothoate, protrifenbute, proxan, proxan-sodium, prynachlor, pydanon, pymetrozine, pyracarbolid, pyraclofos, pyraclonil, pyraclostrobin, pyraflufen, pyraflufen-ethyl, pyrafluprole, pyramat, pyrametostrobin, pyraoxystrobin, pyrasulfotole, pyrazolynate, pyrazophos, pyrazosulfuron, pyrazosulfuron-ethyl, pyrazothion, pyrazoxyfen, pyresmethrin, pyrethrin I, pyrethrin II, pyrethrins, pyribambenz-isopropyl, pyribambenz-propyl, pyribencarb, pyribenzoxim, pyributicarb, pyriclor, pyridaben, pyridafol, pyridalyl, pyridaphenthion, pyridate, pyridinitril, pyrifenox, pyrifluquinazon, pyriftalid, pyrimethanil, pyrimidifen, pyriminobac, pyriminobac-methyl, pyrimisulfan, pyrimitate, pyrinuron, pyriofenone, pyriprole, pyripropanol, pyriproxyfen, pyrithiobac, pyrithiobac-sodium, pyrolan, pyroquilon, pyroxasulfone, pyroxsulam, pyroxychlor, pyroxyfur, quassia, quinacetol, quinacetol sulfate, quinalphos, quinalphos-methyl, quinazamid, quinclorac, quinconazole, quinmerac, quinoclamine, quinonamid, quinothion, quinoxyfen, quintiofos, quintozene, quizalofop, quizalofop-ethyl, quizalofop-P, quizalofop-P-ethyl, quizalofop-P-tefuryl, quwenzhi, quyingding, rabenzazole, rafoxanide, rebemide, resmethrin, rhodethanil, rhodojaponin-III, ribavirin, rimsulfuron, rotenone, ryania, saflufenacil, saijunmao, saisentong, salicylanilide, sanguinarine, santonin, schradan, scilliroside, sebuthylazine, secbumeton, sedaxane, selamectin, semiamitraz, semiamitraz chloride, sesamex, sesamolin, sethoxydim, shuangjiaancaolin, siduron, siglure, silafluofen, silatrane, silica gel, silthiofam, simazine, simeconazole, simeton, simetryn, sintofen, SMA, S-metolachlor, sodium arsenite, sodium azide, sodium chlorate, sodium fluoride, sodium fluoroacetate, sodium hexafluorosilicate, sodium naphthenate, sodium orthophenylphenoxide, sodium pentachlorophenoxide, sodium polysulfide, sodium thiocyanate, sodium α-naphthaleneacetate, sophamide, spinetoram, spinosad, spirodiclofen, spiromesifen, spirotetramat, spiroxamine, streptomycin, streptomycin sesquisulfate, strychnine, sulcatol, sulcofuron, sulcofuron-sodium, sulcotrione, sulfallate, sulfentrazone, sulfiram, sulfluramid, sulfometuron, sulfometuron-methyl, sulfosulfuron, sulfotep, sulfoxaflor, sulfoxide, sulfoxime, sulfur, sulfuric acid, sulfuryl fluoride, sulglycapin, sulprofos, sultropen, swep, tau-fluvalinate, tavron, tazimcarb, TCA, TCA-ammonium, TCA-calcium, TCA-ethadyl, TCA-magnesium, TCA-sodium, TDE, tebuconazole, tebufenozide, tebufenpyrad, tebufloquin, tebupirimfos, tebutam, tebuthiuron, tecloftalam, tecnazene, tecoram, teflubenzuron, tefluthrin, tefuryltrione, tembotrione, temephos, tepa, TEPP, tepraloxydim, terallethrin, terbacil, terbucarb, terbuchlor, terbufos, terbumeton, terbuthylazine, terbutryn, tetcyclacis, tetrachloroethane, tetrachlorvinphos, tetraconazole, tetradifon, tetrafluron, tetramethrin, tetramethylfluthrin, tetramine, tetranactin, tetrasul, thallium sulfate, thenylchlor, theta-cypermethrin, thiabendazole, thiacloprid, thiadifluor, thiamethoxam, thiapronil, thiazafluron, thiazopyr, thicrofos, thicyofen, thidiazimin, thidiazuron, thiencarbazone, thiencarbazone-methyl, thifensulfuron, thifensulfuron-methyl, thifluzamide, thiobencarb, thiocarboxime, thiochlorfenphim, thiocyclam, thiocyclam hydrochloride, thiocyclam oxalate, thiodiazole-copper, thiodicarb, thiofanox, thiofluoximate, thiohempa, thiomersal, thiometon, thionazin, thiophanate, thiophanate-methyl, thioquinox, thiosemicarbazide, thiosultap, thiosultap-diammonium, thiosultap-disodium, thiosultap-monosodium, thiotepa, thiram, thuringiensin, tiadinil, tiaojiean, tiocarbazil, tioclorim, tioxymid, tirpate, tolclofos-methyl, tolfenpyrad, tolylfluanid, tolylmercury acetate, topramezone, tralkoxydim, tralocythrin, tralomethrin, tralopyril, transfluthrin, transpermethrin, tretamine, triacontanol, triadimefon, triadimenol, triafamone, tri-allate, triamiphos, triapenthenol, triarathene, triarimol, triasulfuron, triazamate, triazbutil, triaziflam, triazophos, triazoxide, tribenuron, tribenuron-methyl, tribufos, tributyltin oxide, tricamba, trichlamide, trichlorfon, trichlormetaphos-3, trichloronat, triclopyr, triclopyr-butotyl, triclopyr-ethyl, triclopyr-triethylammonium, tricyclazole, tridemorph, tridiphane, trietazine, trifenmorph, trifenofos, trifloxystrobin, trifloxysulfuron, trifloxysulfuron-sodium, triflumizole, triflumuron, trifluralin, triflusulfuron, triflusulfuron-methyl, trifop, trifop-methyl, trifopsime, triforine, trihydroxytriazine, trimedlure, trimethacarb, trimeturon, trinexapac, trinexapac-ethyl, triprene, tripropindan, triptolide, tritac, triticonazole, tritosulfuron, trunc-call, uniconazole, uniconazole-P, urbacide, uredepa, valerate, validamycin, valifenalate, valone, vamidothion, vangard, vaniliprole, vernolate, vinclozolin, warfarin, warfarin-potassium, warfarin-sodium, xiaochongliulin, xinjunan, xiwojunan, XMC, xylachlor, xylenols, xylylcarb, yishijing, zarilamid, zeatin, zengxiaoan, zeta-cypermethrin, zinc naphthenate, zinc phosphide, zinc thiazole, zineb, ziram, zolaprofos, zoxamide, zuomihuanglong, α-chlorohydrin, α-ecdysone, α-multistriatin, and α-naphthaleneacetic acid.

17. The composition of claim 10, wherein the at least one herbicide is indaziflam and said indaziflam is at least 95% dissolved in said oil in water emulsion or emulsifiable concentrate.

18. The method of claim 1, wherein after being treated with said pesticide, said vegetation recovers up to 6 times more quickly than when said pesticide is applied in a formulation that is not an emulsiable concentrate or oil in water emulsion.
